(19) United States
(12) Patent Application Publication
(10) Pub. No.: US 2026/0064107 A1
(43) Pub. Date: Mar. 5, 2026

(54) DATA PROCESSING DEVICE, DATA PROCESSING METHOD AND COMPUTER READABLE MEDIUM

(71) Applicant: Mitsubishi Electric Corporation, Tokyo (JP)

(72) Inventors: Hiroyuki YAMADA, Tokyo (JP); Atsushi OKAZATO, Tokyo (JP)

(73) Assignee: Mitsubishi Electric Corporation, Tokyo (JP)

(21) Appl. No.: 19/381,814

(22) Filed: Nov. 6, 2025

Related U.S. Application Data
(63) Continuation of application No. PCT/JP2023/023369, filed on Jun. 23, 2023.

(51) Int. Cl. G05B 23/02

(52) U.S. Cl. CPC G05B 23/024; G05B 23/0283

(57) ABSTRACT

A design data acquisition unit (103, 104) acquires design data of a space where equipment is installed as spatial design data, and acquires design data for installing the equipment in the space as installation design data. The decision unit (105) uses the spatial design data and the installation design data, and decides, before the equipment is actually installed in the space, whether the equipment is installed in the space in compliance with installation specifications which are specifications related to the installation of the equipment when the equipment is actually installed in the space.

### CROSS REFERENCE TO RELATED APPLICATION

This application is a Continuation of PCT International Application No. PCT/JP2023/023369, filed on Jun. 23, 2023, which is hereby expressly incorporated by reference into the present application.

### TECHNICAL FIELD

The present disclosure relates to installation of equipment in a space.

### BACKGROUND ART

According to the technique of Patent Literature 1, a spatial proposal system acquires spatial design data indicating the state of the design space.

Further, the spatial proposal system calculates a spatial distribution of environmental information in the design space based on the spatial design data.

Furthermore, the spatial proposal system decides whether the environment in the design space meets a decision criterion used for environment authentication of the real space based on the spatial distribution calculated.

The spatial proposal system calculates the spatial distribution of the PMV (Predicted Mean Vote) in the design space, for instance, and decides whether the environment in the design space meets the decision criterion used for the environment authentication of the real space. The PMV is an index indicating the comfort of a space.

### CITATION LIST

### Patent Literature

Patent Literature 1: WO2021-024807 A

### SUMMARY OF INVENTION

### Technical Problem

In spaces such as buildings and the like, various facilities including air-conditioners, lighting fixtures, and elevators are installed. In order for these facilities to be used safely and appropriately, it is necessary to install the facilities in the space in compliance with installation specifications which are specifications regarding installation of the facilities.

According to the technique of Patent Literature 1, it is possible for the designer to recognize whether the environment in the space meets the decision criterion used for environment authentication in advance.

However, a problem with the technique in Patent Literature 1 is that the designer is unable to recognize whether the equipment is installed in the space in compliance with the installation specifications in advance.

The present disclosure is mainly aimed at resolving this problem. Specifically, the present disclosure is mainly aimed at allowing the designer to recognize whether equipment is installed in a space in compliance with the installation specifications in advance.

### Solution to Problem

A data processing device according to the present disclosure includes
a design data acquisition unit to acquire design data of a space where equipment is installed as spatial design data, and to acquire design data to install the equipment in the space as installation design data, and
a decision unit to decide, before the equipment is actually installed in the space, whether the equipment is to be installed in the space in compliance with an installation specification being a specification on installation of the equipment when the equipment is actually installed in the space, using the spatial design data and the installation design data.

### Advantageous Effects of Invention

According to the present disclosure, it is possible for the designer to recognize whether equipment is installed in a space in compliance with the installation specifications in advance.

### BRIEF DESCRIPTION OF DRAWINGS

FIG. 1 is a diagram illustrating a configuration example of a data processing system according to First Embodiment;

FIG. 2 is a diagram illustrating an example of a functional configuration of the data processing device according to First Embodiment;

FIG. 3 is a diagram illustrating an example of a hardware configuration of the data processing device according to First Embodiment;

FIG. 4 is a diagram illustrating an example of architecture BIM data according to First Embodiment;

FIG. 5 is a diagram illustrating an example of an equipment BIM object according to First Embodiment;

FIG. 6 is a diagram illustrating an example of equipment BIM data according to First Embodiment;

FIG. 7 is a flowchart illustrating an operational example of the data processing device according to First Embodiment;

FIG. 8 is a flowchart illustrating an operational example of the data processing device according to First Embodiment;

FIG. 9 is a diagram illustrating an example of a decision result according to First Embodiment;

FIG. 10 is a diagram illustrating a configuration example of the data processing system according to Second Embodiment;

FIG. 11 is a diagram illustrating an example of a functional configuration of the data processing device according to Second Embodiment;

FIG. 12 is a diagram illustrating an example of specification compliance status data according to Second Embodiment;

FIG. 13 is a diagram illustrating an example of workload volume data according to Second Embodiment;

FIG. 14 is a flowchart illustrating an operational example of the data processing device according to Second Embodiment;

FIG. 15 is a flowchart illustrating an operational example of the data processing device according to Second Embodiment;

FIG. 16 is a flowchart illustrating an operational example of the data processing device according to Second Embodiment;

FIG. 17 is a diagram illustrating an example of a workload reduction contribution table according to Second Embodiment;

FIG. 18 is a diagram illustrating an example of a workload reduction contribution table according to Second Embodiment;

FIG. 19 is a diagram illustrating an example of a workload reduction contribution table according to Second Embodiment;

FIG. 20 is a diagram illustrating a configuration example of the data processing system according to Second Embodiment;

FIG. 21 is a diagram illustrating an example of specification compliance status data according to Second Embodiment;

FIG. 22 is a diagram illustrating a configuration example of the data processing system according to Fourth Embodiment;

FIG. 23 is a diagram illustrating an example of correction value candidate data according to Fourth Embodiment;

FIG. 24 is a diagram illustrating an example of a functional configuration of the data processing device according to Fourth Embodiment;

FIG. 25 is a flowchart illustrating an operational example of the data processing device according to Fourth Embodiment;

FIG. 26 is a flowchart illustrating an operational example of the data processing device according to Fourth Embodiment;

FIG. 27 is a diagram illustrating an example of a correction value candidate table according to Fourth Embodiment;

FIG. 28 is a diagram illustrating an example of a correction value candidate table according to Fifth Embodiment;

FIG. 29 is a diagram illustrating an example of a two-dimensional graph according to Sixth Embodiment;

FIG. 30 is a diagram illustrating a configuration example of the data processing system according to Sixth Embodiment;

FIG. 31 is a diagram illustrating an example of specification compliance status data related to Sixth Embodiment;

FIG. 32 is a diagram illustrating an example of an equipment BIM object according to a first variation of First Embodiment;

FIG. 33 is a diagram illustrating a configuration example of the data processing system according to the first variation of First Embodiment;

FIG. 34 is a diagram illustrating an example of equipment BIM data according to the first variation of First Embodiment;

FIG. 35 is a diagram illustrating a configuration example of the data processing system according to a second variation of First Embodiment; and

FIG. 36 is a diagram illustrating a configuration example of the data processing system according to a third variation of First Embodiment.

### DESCRIPTION OF EMBODIMENTS

Hereinafter, embodiments will be described using diagrams. In the following description of the embodiment and the diagrams, the elements that are assigned the same reference numerals indicate the same or corresponding elements.

### First Embodiment

### Description of Configuration

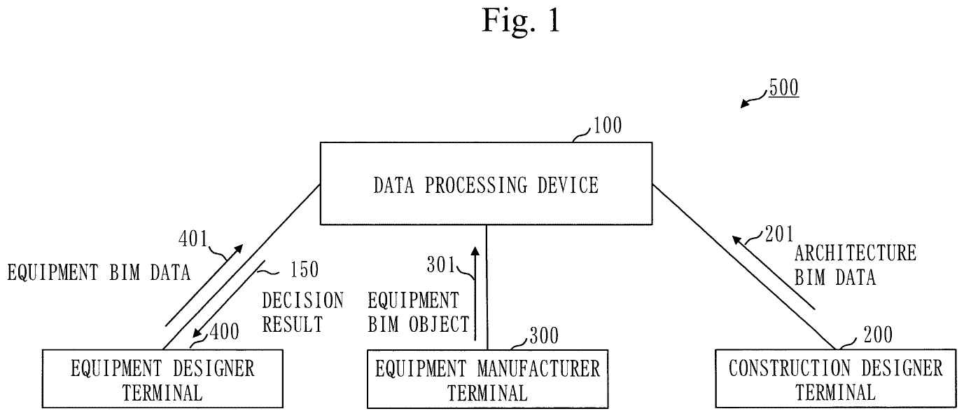

FIG. 1 illustrates a configuration example of a data processing system 500 according to the present embodiment.

The data processing system 500 includes a data processing device 100, a construction designer terminal 200, an equipment manufacturer terminal 300, and an equipment designer terminal 400.

The construction designer terminal 200 is a terminal device used by a construction designer. The construction designer designs buildings.

The construction designer terminal 200 transmits architecture BIM (Building Information Modelling) data 201 to the data processing device 100.

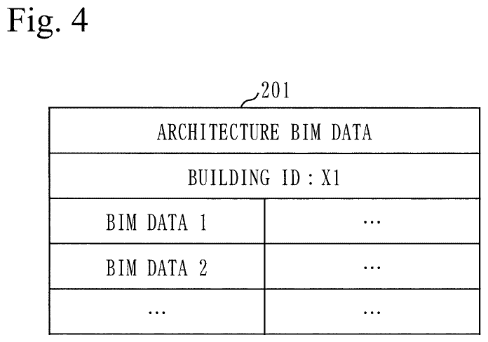

FIG. 4 illustrates an example of the architecture BIM data 201. As illustrated in FIG. 4, the architecture BIM data 201 includes a building ID (Identifier) that uniquely identifies the target building. In addition, the architecture BIM data 201 includes multiple pieces of BIM data on the three-dimensional shape and size of the target building. The BIM data included in the architecture BIM data 201 is, for instance, three-dimensional CAD (Computer Aided Design) data of a building.

The architecture BIM data 201 is design data for the building where equipment is installed.

A building is one example of a space where the equipment is installed. The space where the equipment is installed is not limited to a building whose periphery is surrounded by walls, but may also be a space that is not surrounded by walls, such as a sidewalk, a road, a park, and the like.

The architecture BIM data 201 is an example of spatial design data.

The equipment manufacturer terminal 300 is a terminal device used by equipment manufacturers.

The equipment manufacturer terminal 300 transmits an equipment BIM object 301 to the data processing device 100.

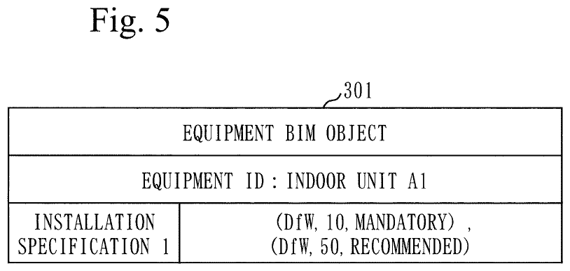

FIG. 5 illustrates an example of the equipment BIM object 301. As illustrated in FIG. 5, the equipment BIM object 301 includes an equipment ID that uniquely identifies the target equipment.

The equipment is, for example, an indoor unit of an air conditioning unit, an outdoor unit of an air conditioning unit, a lighting fixture, lighting control-related equipment, ventilation equipment, an elevating machine, an entrance/exit management equipment.

Further, the equipment BIM object 301 describes one or more installation specifications, which are specifications related to installation of the target equipment.

Each installation specification includes both mandatory and recommended specifications.

The mandatory specification is a specification that is necessary to be complied with when equipment is installed. The mandatory specification is a specification that, if not complied with, for example, may cause the equipment to operate improperly.

A recommended specification is a specification that is recommended to be complied with when equipment is installed. The equipment operates properly even if the recommended specification is not complied with. However, if the recommended specification is complied with, useful effects can be expected. For instance, if the recommended specification is complied with, such effects are expected that the maintenance work for equipment becomes easier and requires only a short time.

When the equipment to be installed is an indoor unit of air conditioning unit (also simply called an indoor unit), the following mandatory and recommended specifications, for instance, may be considered:
mandatory specification: place the indoor unit 10 cm or more away from the wall, and
recommended specification: place the indoor unit 50 cm or more away from the wall.

It is considered that the mandatory and recommended specification are defined as (parameter name, parameter value, classification of mandatory specification or recommended specification) in the equipment BIM object 301.

Specifically, it is considered that the mandatory specification and the recommended specification are defined as exemplified in FIG. 5.

In FIG. 5, “Dfw” denotes a distance between an indoor unit and a wall. Further, parameter values are denoted in centimeters.

The equipment designer terminal 400 is a terminal device used by an equipment designer. The equipment designer carries out design to install equipment in a building subject to the architecture BIM data 201.

The equipment designer terminal 400 transmits equipment BIM data 401 to the data processing device 100.

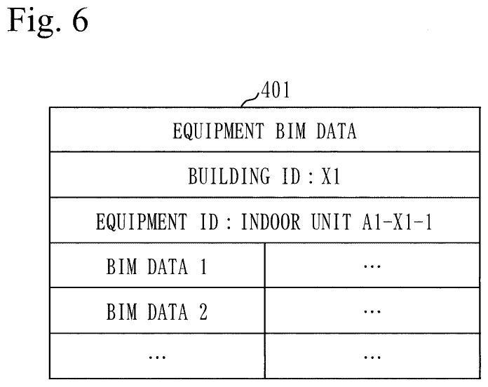

FIG. 6 illustrates an example of the equipment BIM data 401.

As illustrated in FIG. 6, the equipment BIM data 401 includes a building ID of the target building and an equipment ID of the target equipment.

In the present embodiment, it is assumed that multiple indoor units are installed in a building.

An equipment ID included in the equipment BIM data 401 is a character string obtained by adding a building ID and a serial number to the equipment ID of the equipment BIM object 301, in order to specify each piece of equipment and the building where each piece of equipment is installed. In the example of FIG. 6, “indoor unit A1-X1-1” is set as the equipment ID.

Further, the equipment BIM data 401 includes multiple pieces of BIM data on three-dimensional shape and size to install the target equipment. The BIM data included in the equipment BIM data 401 is, for example, three-dimensional CAD data to install equipment.

The equipment BIM data 401 is design data to install equipment in a building.

The equipment BIM data 401 is an example of the installation design data.

The data processing device 100 receives the architecture BIM data 201 from the construction designer terminal 200.

Additionally, the data processing device 100 receives the equipment BIM object 301 from the equipment manufacturer terminal 300.

Furthermore, the data processing device 100 receives the equipment BIM data 401 from the equipment designer terminal 400.

Then, the data processing device 100 decides, before equipment is actually installed in a building, whether the equipment is installed in the building in compliance with the installation specifications described in the equipment BIM object 301 when the equipment is actually installed in the building by using the architecture BIM data 201 and the equipment BIM data 401. More specifically, the data processing device 100 decides whether the equipment is installed in the building in compliance with the mandatory specification, and whether the equipment is installed in the building in compliance with the recommended specification.

Then, the data processing device 100 transmits a decision result 150 to the equipment designer terminal 400, for example.

Note that the operation procedure of the data processing device 100 corresponds to a data processing method. Additionally, the program that realizes the operation of the data processing device 100 corresponds to a data processing program.

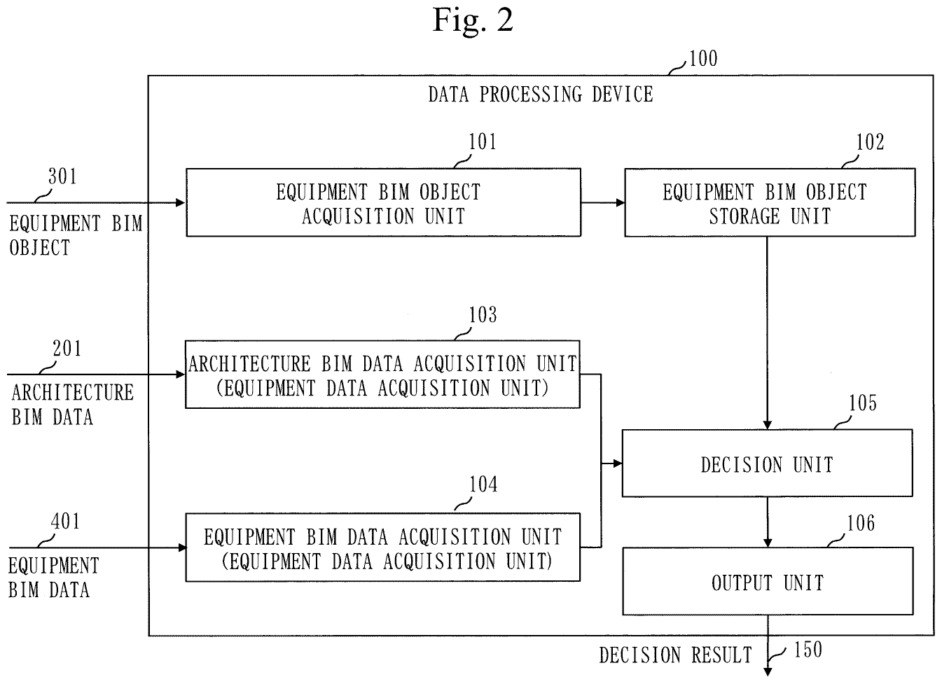

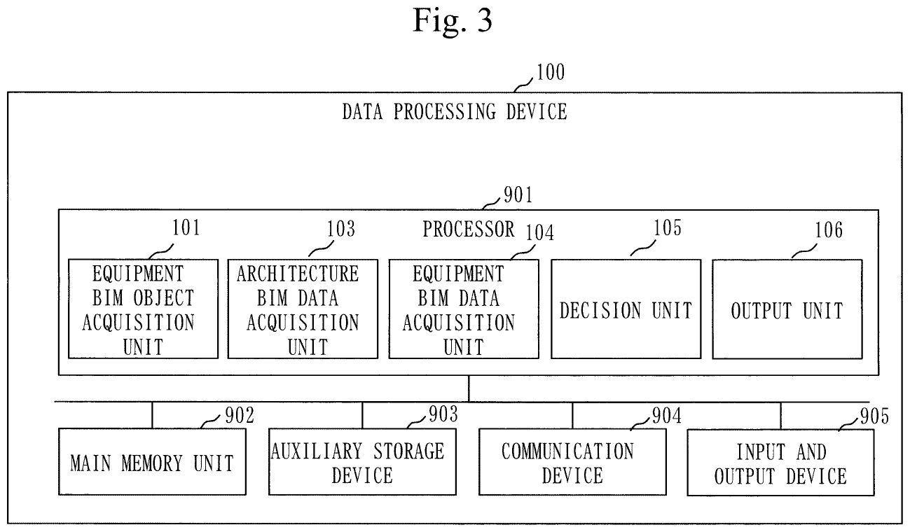

FIG. 2 illustrates an example of a functional configuration of the data processing device 100. Furthermore, FIG. 3 illustrates an example of a hardware configuration of the data processing device 100.

First, a description will be given on the example of the hardware configuration of the data processing device 100 illustrated in FIG. 3.

The data processing device 100 is a computer.

The data processing device 100 includes a processor 901, a main memory unit 902, an auxiliary storage device 903, a communication device 904, and an input and output device 905 as hardware components.

Further, the data processing device 100 includes an equipment BIM object acquisition unit 101, an equipment BIM object storage unit 102, an architecture BIM data acquisition unit 103, an equipment BIM data acquisition unit 104, a decision unit 105 and an output unit 106 as functional components, as illustrated in FIG. 2.

The functions of the equipment BIM object acquisition unit 101, the architecture BIM data acquisition unit 103, the equipment BIM data acquisition unit 104, the decision unit 105, and the output unit 106 are realized by programs, for instance.

The auxiliary storage device 903 stores the programs that realize the functions of the equipment BIM object acquisition unit 101, the architecture BIM data acquisition unit 103, the equipment BIM data acquisition unit 104, the decision unit 105, and the output unit 106.

These programs are loaded to the main memory unit 902 from the auxiliary storage device 903. Then, the processor 901 executes these programs and performs the operations of the equipment BIM object acquisition unit 101, the architecture BIM data acquisition unit 103 and the like described later.

FIG. 3 schematically describes the state where the processor 901 executes the programs that realize the functions of the equipment BIM object acquisition unit 101, the architecture BIM data acquisition unit 103 and the like.

The equipment BIM object storage unit 102 illustrated in FIG. 2 is realized by the main memory unit 902 and/or the auxiliary storage device 903, for example.

The communication device 904 communicates with the construction designer terminal 200, the equipment manufacturer terminal 300, and the equipment designer terminal 400.

The input and output device 905 includes a mouse, a keyboard, a display, and the like.

Next, a description will be given on the functional components of the data processing device 100 illustrated in FIG. 2.

The equipment BIM object acquisition unit 101 illustrated in FIG. 2 acquires (receives) the equipment BIM object 301 from the equipment manufacturer terminal 300, using the communication device 904.

Then, the equipment BIM object acquisition unit 101 stores the equipment BIM object 301 in the equipment BIM object storage unit 102.

The equipment BIM object storage unit 102 stores the equipment BIM object 301.

The architecture BIM data acquisition unit 103 acquires (receives) the architecture BIM data 201 from the construction designer terminal 200, using the communication device 904.

Then, the architecture BIM data acquisition unit 103 outputs the architecture BIM data 201 to the decision unit 105.

The architecture BIM data acquisition unit 103, together with the equipment BIM data acquisition unit 104, corresponds to a design data acquisition unit. Further, the process performed by the architecture BIM data acquisition unit 103, together with the process performed by the equipment BIM data acquisition unit 104, corresponds to a design data acquisition process.

The equipment BIM data acquisition unit 104 acquires (receives) the equipment BIM data 401 from the equipment designer terminal 400, using the communication device 904.

Then, the equipment BIM data acquisition unit 104 outputs the equipment BIM data 401 to the decision unit 105.

The equipment BIM data acquisition unit 104, together with the architecture BIM data acquisition unit 103, corresponds to a design data acquisition unit. Further, the process performed by the equipment BIM data acquisition unit 104, together with the process performed by the architecture BIM data acquisition unit 103, corresponds to a design data acquisition process.

The decision unit 105 acquires the architecture BIM data 201 from the architecture BIM data acquisition unit 103. In addition, the decision unit 105 acquires the equipment BIM data 401 from the equipment BIM data acquisition unit 104.

Furthermore, the decision unit 105 reads the equipment BIM object 301 from the equipment BIM object storage unit 102.

Then, the decision unit 105 decides, before the equipment is actually installed in the building, whether the equipment is installed in compliance with the installation specifications when the equipment is actually installed in the building, using the architecture BIM data 201 and the equipment BIM data 401. In other words, the decision unit 105 decides whether the equipment is installed in compliance with the installation specifications described in the equipment BIM object 301 when the equipment is installed according to the equipment BIM data 401, through a simulation using the architecture BIM data 201 and the equipment BIM data 401.

More specifically, the decision unit 105 decides whether the equipment is installed in the building in compliance with the mandatory specification, and whether the equipment is installed in the building in compliance with the recommended specification.

The process performed by the decision unit 105 corresponds to a decision process.

The output unit 106 transmits the decision result 150 by the decision unit 105 to the equipment designer terminal 400, using the communication device 904, for example.

### Description of Operation

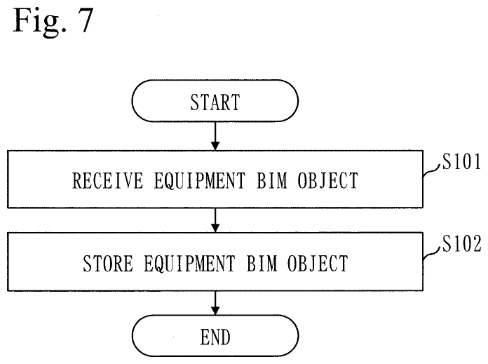

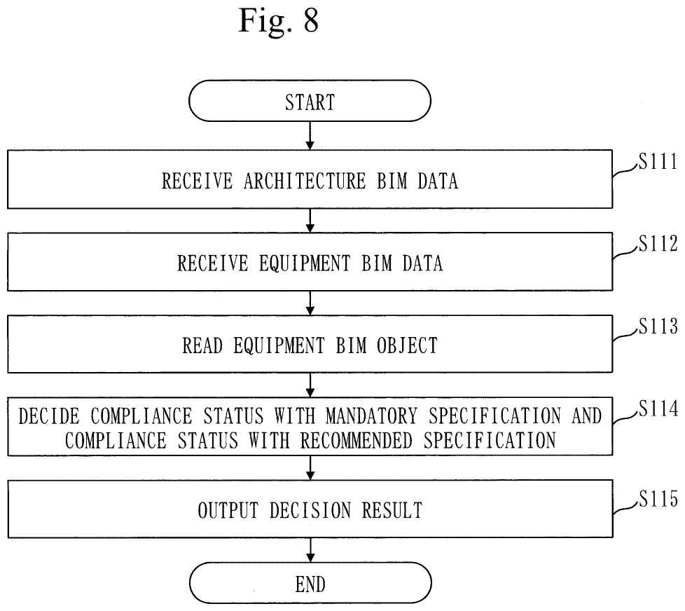

Next, a description will be given on the operation example of the data processing device 100 with reference to FIG. 7 and FIG. 8.

Note that a description will be given hereinafter using an indoor unit as an example of the equipment.

First, in Step S101 in FIG. 7, the equipment BIM object acquisition unit 101 receives the equipment BIM object 301 from the equipment manufacturer terminal 300, using the communication device 904.

Next, in Step S102, the equipment BIM object storage unit 102 stores the equipment BIM object 301.

Next, in Step S111 of FIG. 8, the architecture BIM data acquisition unit 103 receives the architecture BIM data 201 from the construction designer terminal 200, using the communication device 904. Subsequently, the architecture BIM data acquisition unit 103 outputs the architecture BIM data 201 received to the decision unit 105.

The decision unit 105 acquires the architecture BIM data 201 from the architecture BIM data acquisition unit 103.

Next, in Step S112, the equipment BIM data acquisition unit 104 receives the equipment BIM data 401 from the equipment designer terminal 400, using the communication device 904.

Note that, in a case where multiple pieces of equipment are installed in a building, the equipment BIM data acquisition unit 104 receives equipment BIM data 401 for each piece of equipment installed. For example, in a case where 10 indoor units are installed in the building, the equipment BIM data acquisition unit 104 receives 10 pieces of equipment BIM data 401, one for each indoor unit.

The equipment BIM data acquisition unit 104 outputs the equipment BIM data 401 received to the decision unit 105. The decision unit 105 acquires the equipment BIM data 401 from the equipment BIM data acquisition unit 104.

Note that the equipment BIM data 401 received in Step S112 shall contain an equipment ID that corresponds to the equipment ID included in the equipment BIM object 301 received in Step S101, and a building ID that is the same as the building ID included in the architecture BIM data 201 received in Step S111.

The equipment ID that corresponds to the equipment ID included in the equipment BIM object 301 means an equipment ID in which the character string except for the parts of the building ID and the serial number is the same as that in the equipment ID included in the equipment BIM object 301. In the equipment ID of the equipment BIM data 401 in FIG. 6, the character string (indoor unit A1) except for the parts of the building ID and the serial number (-X1-1) is the same as that in the equipment ID (indoor unitA1) of the equipment BIM object 301 in FIG. 5. Therefore, the equipment ID included in the equipment BIM data 401 in FIG. 6 corresponds to the equipment ID included in the equipment BIM object 301 in FIG. 5.

Further, instead of the above, the equipment BIM data acquisition unit 104 may also receive one piece of equipment BIM data 401 for multiple pieces of equipment installed in one building. In this case, the equipment BIM data 401 lists pairs of the equipment ID and BIM data indicated in FIG. 6 for each piece of equipment under the building ID indicated in FIG. 6. The equipment BIM data acquisition unit 104 identifies the BIM data of the corresponding equipment, using the equipment ID.

The execution order of Step S111 and Step S112 may be replaced. Alternatively, Step S111 and Step S112 can be performed in parallel.

Next, in Step S113, the decision unit 105 reads the equipment BIM object 301 from the equipment BIM object storage unit 102.

Specifically, the equipment BIM object storage unit 102 reads the equipment BIM object 301 which includes the equipment ID corresponding to the equipment ID included in the equipment BIM data 401 received in Step S112.

Next, in Step S114, the decision unit 105 decides a compliance status with the mandatory specification and a compliance status with the recommended specification, using the architecture BIM data 201 and the equipment BIM data 401.

Specifically, the decision unit 105 calculates an installation status value which is a numerical value that represents the installation status of equipment in a building. Then, the decision unit 105 compares the installation status value with the numerical value of the mandatory specification, and decides whether the equipment is installed in the building in compliance with the mandatory specification. Similarly, the decision unit 105 compares the installation status value with the numerical value of the recommended specification, and decides whether the equipment is installed in the building in compliance with the recommended specification.

For example, it is assumed that the following mandatory specification and recommended specification as mentioned earlier are described in the equipment BIM object 301. In this case, the decision unit 105 calculates the distance between the wall and the indoor unit as the installation status value.

Mandatory specification: place the indoor unit 10 cm or more away from the wall.

Recommended specification: place the indoor unit 50 cm or more away from the wall.

In other words, the decision unit 105 analyzes the architecture BIM data 201, and decides the three-dimensional position of the wall.

Additionally, the decision unit 105 analyzes the equipment BIM data 401, and decides the three-dimensional position of the indoor unit.

Furthermore, the decision unit 105 calculates the distance between the wall and the indoor unit (installation status value) based on the decision result of the three-dimensional position of the wall and the decision result of the three-dimensional position of the indoor unit.

Then, the decision unit 105 decides whether the distance calculated satisfies each of the mandatory specification and the recommended specification.

For instance, when the calculated distance between the wall and the indoor unit is 40 cm, the decision unit 105 decides that the mandatory specification is met, but the recommended specification is not met.

Further, for example, if there are multiple indoor units installed in a building, the decision unit 105 performs a similar process for each indoor unit, and decides the compliance status with the mandatory specification and the compliance status of the recommended specification for each indoor unit.

Moreover, when the equipment BIM object 301 includes multiple installation specifications (mandatory specifications and recommended specifications), the decision unit 105 performs a similar process for each installation specification, and decides the compliance status for each installation specification.

Once the decision in Step S114 is completed for all installation specifications and all pieces of equipment, the output unit 106 transmits the decision result 150 to the equipment designer terminal 400, using the communication device 904, for example, in Step S115. The output unit 106 may transmit the decision result 150 to the construction designer terminal 200 instead of the equipment designer terminal 400. In addition, the output unit 106 mat transmit the decision result 150 to both the equipment designer terminal 400 and the construction designer terminal 200. Moreover, the output unit 106 may output the decision result 150 on a display included in the input and output device 905 without transmitting the decision result 150 to either the equipment designer terminal 400 or the construction designer terminal 200.

The decision result 150 may include the installation status value (for example, the distance between the wall and the indoor unit is 40 cm) calculated by the decision unit 105.

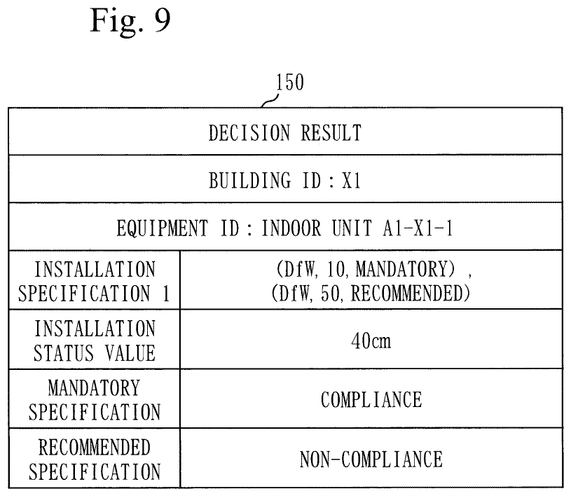

FIG. 9 illustrates an example of the decision result 150. In the example of FIG. 9, for the installation specification 1, the installation status value (40 cm), and the compliance statuses with the mandatory specification and the recommended specification (the mandatory specification is “compliance”, and the recommended specification is “non-compliance”) are indicated.

### Description of Effect of Embodiment

As described, in the present embodiment, the data processing device 100 decides the compliance status with installation specifications of equipment prior to installation of the equipment. Therefore, according to the present embodiment, it is possible for construction designers and/or equipment designers to recognize in advance whether the equipment is installed in compliance with the installation specifications. Moreover, according to the present embodiment, human error during installation of equipment is reduced, and the efficiency of installation work of the equipment is improved.

### First Variation

While in First Embodiment the equipment BIM data 401 may be generated in any manner, it is conceivable that the equipment designer generates the equipment BIM data 401with use of the equipment BIM object 301, for instance.

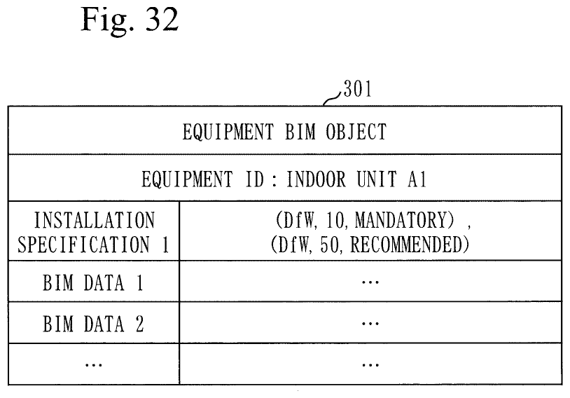

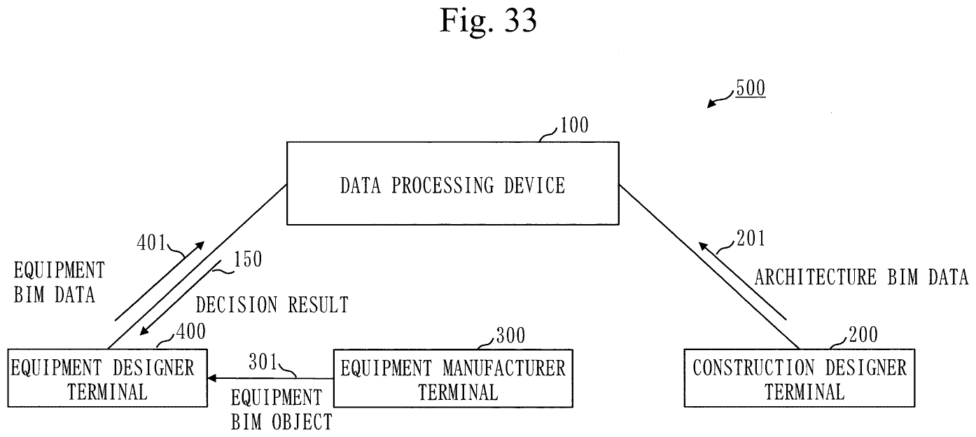

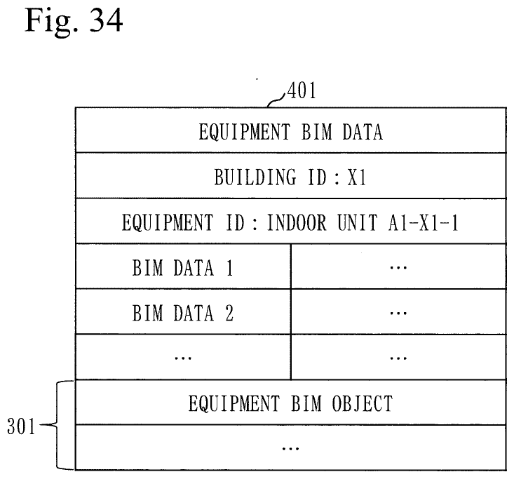

In this case, as illustrated in FIG. 32, the equipment BIM object 301 includes multiple pieces of BIM data on three-dimensional shape and size for installing equipment. Further, in this case, as illustrated in FIG. 33, the equipment designer terminal 400 acquires the equipment BIM object 301 from the equipment manufacturer terminal 300. Subsequently, the equipment designer generates the equipment BIM data 401 with use of the equipment BIM object 301, and the equipment designer terminal 400 transmits the equipment BIM data 401 to the data processing device 100. In this case, the equipment BIM data 401 that the data processing device 100 receives includes the equipment BIM object 301, as illustrated in FIG. 34.

In addition, in this case, there is no necessity for the data processing device 100 to acquire the equipment BIM object 301 from the equipment manufacturer terminal 300, as illustrated in FIG. 33.

In this case as well, the process by the data processing device 100 is the same as that previously described.

### Second Variation

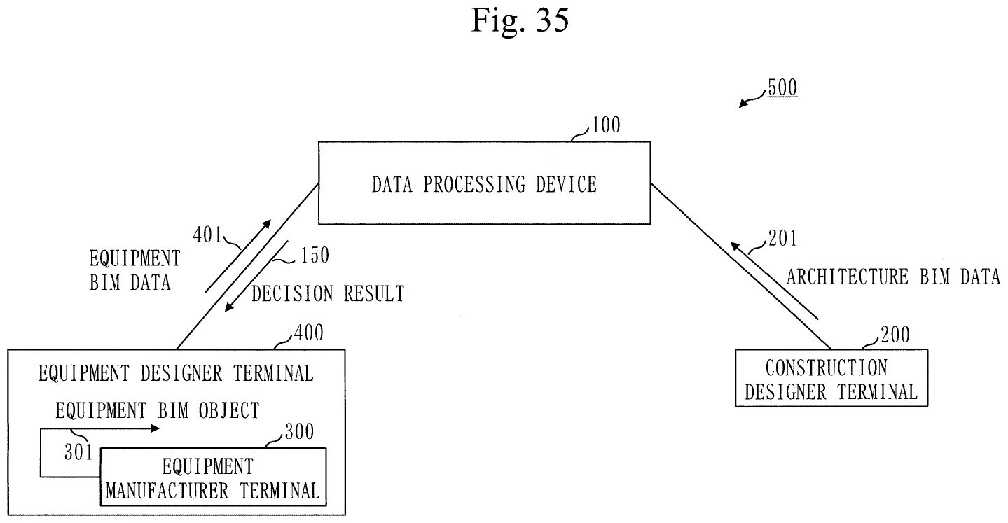

In First Embodiment, the equipment manufacturer terminal 300 and the equipment designer terminal 400 are treated as separate devices. Instead of this, the equipment manufacturer terminal 300 and the equipment designer terminal 400 may be integrated as illustrated in FIG. 35. In this case, the equipment designer generates the equipment BIM object 301 and further generates the equipment BIM data 401 with use of the equipment BIM object 301. Then, the equipment designer terminal 400 transmits the equipment BIM data 401 to the data processing device 100. In this case, the equipment BIM data 401 received by the data processing device 100 includes the equipment BIM object 301, as with First Variation, as illustrated in FIG. 34.

Even in this case, the processing by the data processing device 100 is the same as that previously described.

### Third Variation

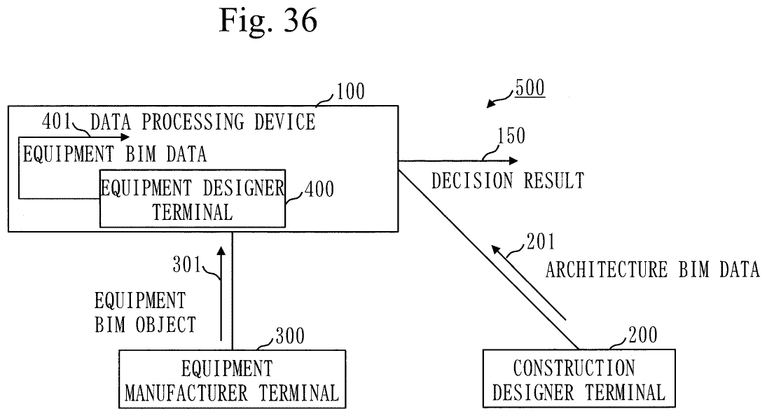

In First Embodiment, the data processing device 100 and the equipment designer terminal 400 are separate devices. Instead of this, the data processing device 100 and the equipment designer terminal 400 may be integrated as illustrated in FIG. 36. That is, the data processing device 100 generates the equipment BIM data 401 as the equipment designer terminal 400, and further decides the compliance status with the mandatory specification and the compliance status with the recommended specification with use of the equipment BIM data 401. Even in this case, the processing by the data processing device 100 is the same as that previously described.

Then, the data processing device 100 outputs the decision result 150 on the display of the input and output device 905, for example.

### Second Embodiment

In the present embodiment, a description will be given on an example of deciding whether the recommended specification contributes to reducing the workload of maintenance work for equipment.

In some cases, equipment is installed without being able to comply with the recommended specifications due to various reasons. As described in First Embodiment, an effect such that being in compliance with the recommended specification facilitates maintenance work for equipment is assumed.

Therefore, it is conceivable that there is a difference between the workload volume of maintenance work for the equipment installed in compliance with the recommended specification and the workload volume of maintenance work for the equipment installed in non-compliance with the recommended specification.

Additionally, it is desirable to verify whether the recommended specification is useful in reducing the workload based on the degree of difference in workload between the case in compliance with the recommended specification, and the case in non-compliance with the recommended specification.

For example, when the workload volume of maintenance work for equipment installed in compliance with the recommended specification is significantly less than that for equipment installed in non-compliance with the recommended specification, the recommended specification is considered to contribute to the reduction of the workload volume. In this case, it is desirable to maintain the recommended operations.

On the other hand, in a case where no significant difference is found, it is considered that the recommended specification does not contribute to reduction of the workload volume. In this case, there is no need to maintain the recommended operations.

In the present embodiment, from such a perspective, a description will be given on an example of deciding the necessity of the recommended specification based on the compliance status with the recommended specification and the workload volume of maintenance work in a past case of installation of equipment.

In the present embodiment, a description will be given mainly on the differences from First Embodiment.

Note that items not described hereinafter are the same as those in First Embodiment.

Further, in the following, a description will be given using an indoor unit as an example of the equipment.

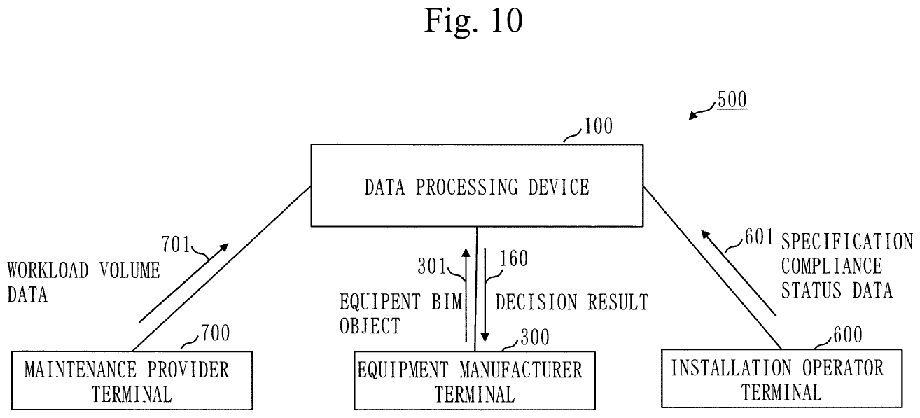

FIG. 10 illustrates a configuration example of the data processing system 500 according to the present embodiment.

In comparison to FIG. 1, in FIG. 10, the construction designer terminal 200 and the equipment designer terminal 400 are omitted, and an installation operator terminal 600 and a maintenance provider terminal 700 are added.

In FIG. 10, although the configuration example where the construction designer terminal 200 and the equipment designer terminal 400 are not present is illustrated, the construction designer terminal 200 and the equipment designer terminal 400 may be present as with FIG. 1.

The equipment manufacturer terminal 300 and the equipment BIM object 301 are the same as those illustrated in FIG. 1. Therefore, the description of the equipment manufacturer terminal 300 and the equipment BIM object 301 is omitted.

The installation operator terminal 600 is a terminal device used by installation operators. The installation operators perform installation works for equipment.

The installation operator terminal 600 transmits specification compliance status data 601 to the data processing device 100. The installation operator terminal 600 transmits the specification compliance status data 601 for each past case of installation where the equipment is installed. When multiple pieces of equipment are installed in one building, each installation is treated as a different past case of installation. For example, if 10 pieces of equipment are installed in one building, there exist 10 past cases of installation.

The specification compliance status data 601 indicates the compliance status with the mandatory specification and the compliance status with the recommended specification in installation of equipment.

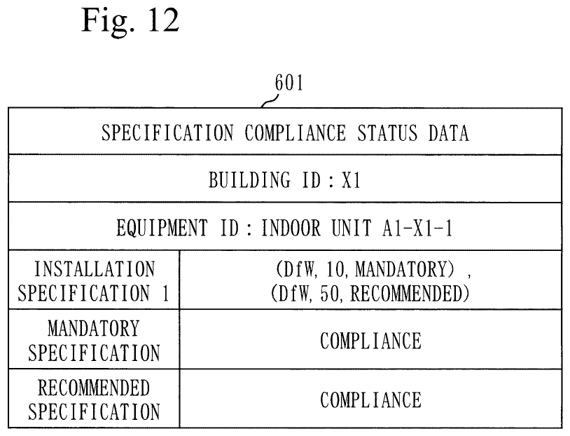

FIG. 12 illustrates an example of the specification compliance status data 601.

The specification compliance status data 601 indicates a building ID, an equipment ID, an installation specification, a compliance status with the mandatory specification, and a compliance status with the recommended specification.

The building ID and the installation specifications are the same as those described in First Embodiment. Further, an equipment ID corresponding to the equipment ID of the equipment BIM data 401 is set in the specification compliance status data 601.

The compliance status with the mandatory specification indicates whether the equipment is installed in compliance with the mandatory specification when the equipment is actually installed. Similarly, the compliance status with the recommended specification indicates whether the equipment is installed in compliance with the recommended specification when the equipment is actually installed.

The maintenance provider terminal 700 is a terminal device used by the maintenance provider. The maintenance provider performs the maintenance work for the equipment.

The maintenance provider terminal 700 transmits workload volume data 701 to the data processing device 100. The maintenance provider terminal 700 transmits the workload volume data 701 for each past case of installation.

The workload volume data 701 indicates the workload volume in the maintenance work for the equipment.

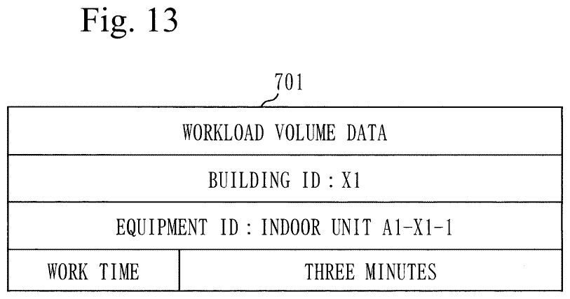

FIG. 13 indicates an example of the workload volume data 701.

The workload volume data 701 indicates a building ID, an equipment ID, and a workload volume.

The building ID and the equipment ID are the same as those described in First Embodiment.

The workload volume is a quantified value of the load required for the maintenance work for the equipment. In the present embodiment, the time required for the maintenance work (hereinafter referred to as work time) is used as the workload volume.

The data processing device 100 receives the equipment BIM object 301 from the equipment manufacturer terminal 300 as with First Embodiment.

Additionally, the data processing device 100 receives multiple pieces of specification compliance status data 601 regarding multiple past cases of installation from the installation operator terminal 600, and stores the multiple pieces of specification compliance status data 601.

Furthermore, the data processing device 100 receives multiple pieces of workload volume data 701 regarding multiple past cases of installation from the maintenance provider terminal 700, and stores the multiple pieces of workload volume data 701.

In addition, the data processing device 100 decides whether it is necessary to correct the recommended specification of the equipment BIM object 301 based on the compliance status of the recommended specification in the multiple pieces of specification compliance status data 601 and the work time in the multiple pieces of workload volume data 701.

Then, the data processing device 100 transmits a decision result 160 to the equipment manufacturer terminal 300. If it is decided that the correction of the recommended specification is necessary in the decision result 160, the equipment manufacturer considers the correction of the recommended specification.

In the present embodiment, the data processing device 100 decides whether to maintain or delete the recommended specification as the decision on whether correction of the recommended specification is necessary. Therefore, the decision result 160 indicates a proposal for maintenance or a proposal for deletion of the recommended specification. The equipment manufacturer refers to the decision result 160, and considers whether to maintain or delete the recommended specification.

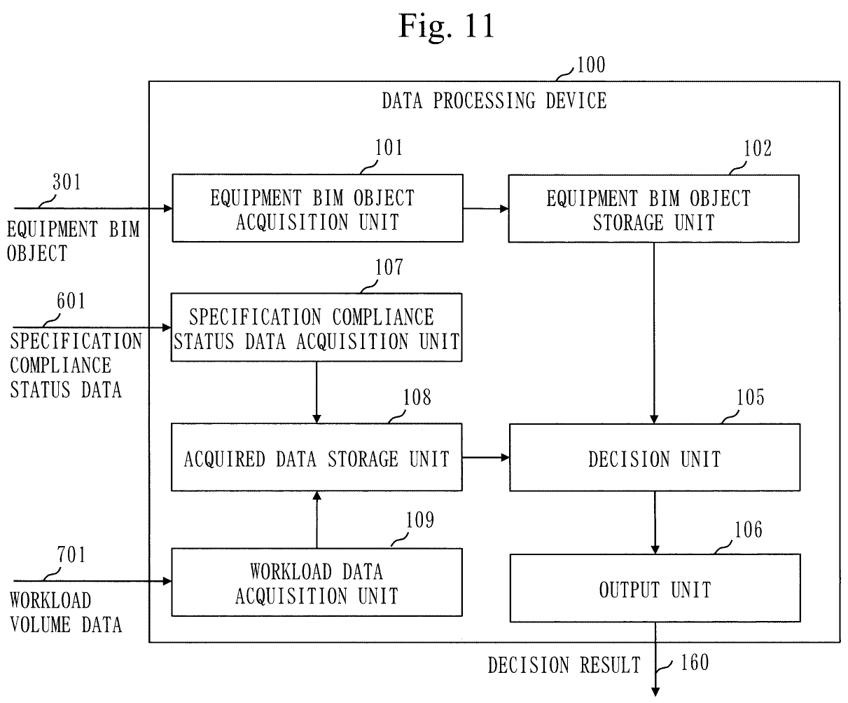

FIG. 11 indicates an example of the functional configuration of the data processing device 100 according to the present embodiment.

Note that the example of the hardware configuration of the data processing device 100 according to the present embodiment is as illustrated in FIG. 3.

The equipment BIM object acquisition unit 101 and the equipment BIM object storage unit 102 are the same as those illustrated in FIG. 2. Therefore, the description on the equipment BIM object acquisition unit 101 and the equipment BIM object storage unit 102 is omitted.

A specification compliance status data acquisition unit 107 acquires the specification compliance status data 601 from the installation operator terminal 600, using the communication device 904.

Then, the specification compliance status data acquisition unit 107 stores the specification compliance status data 601 in an acquired data storage unit 108.

The specification compliance status data acquisition unit 107 is realized by a program as with the equipment BIM object acquisition unit 101 and the like. In addition, the processor 901 executes a program that realizes the specification compliance status data acquisition unit 107 as with the equipment BIM object acquisition unit 101 and the like.

Note that the process performed by the specification compliance status data acquisition unit 107 corresponds to a specification compliance status data acquisition process.

A workload data acquisition unit 109 acquires the workload volume data 701 from the maintenance provider terminal 700, using the communication device 904.

Then, the workload data acquisition unit 109 stores the workload volume data 701 in the acquired data storage unit 108.

The workload data acquisition unit 109 is realized by a program as with the equipment BIM object acquisition unit 101 and the like. Further, the processor 901 executes the program that realizes the workload data acquisition unit 109 as with the equipment BIM object acquisition unit 101 and the like.

It should be noted that the process performed by the workload data acquisition unit 109 corresponds to a workload data acquisition process.

The acquired data storage unit 108 stores the specification compliance status data 601 and the workload volume data 701.

The acquired data storage unit 108 is realized by the main memory unit 902 and/or the auxiliary storage device 903 as with the equipment BIM object storage unit 102.

In the present embodiment, the decision unit 105 reads out the equipment BIM object 301 from the equipment BIM object storage unit 102. In addition, the decision unit 105 reads out the multiple pieces of specification compliance status data 601 and the multiple pieces of workload volume data 701 corresponding to the equipment BIM object 301 from the acquired data storage unit 108.

Furthermore, the decision unit 105 decides whether it is necessary to correct the recommended specification of the equipment BIM object 301 based on the compliance status of the recommended specification in the multiple pieces of specification compliance status data 601 and the work time in the multiple pieces of workload volume data 701. More specifically, by using either the total value or the mean value of work time in the past cases of installation where the equipment is installed in compliance with the recommended specifications and the total value or the mean value of the work time in the past cases of installation where the equipment is installed in non-compliance with the recommended specification, the decision unit 105 decides whether the recommended specification contributes to reduction of the workload in installing the equipment, and thus whether correction of the recommended specification is necessary. In the present embodiment, the decision unit 105 decides whether to maintain or delete the recommended specification as a decision on whether the correction of the recommended specification is necessary.

Even in the present embodiment, the process performed by the decision unit 105 corresponds to a deciding process.

The output unit 106 outputs the decision result 160 by the decision unit 105 to the equipment manufacturer terminal 300, using the communication device 904.

### Description of Operation

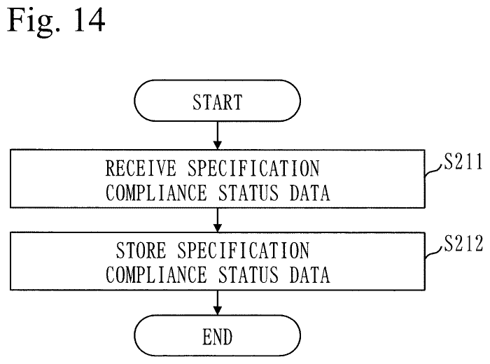

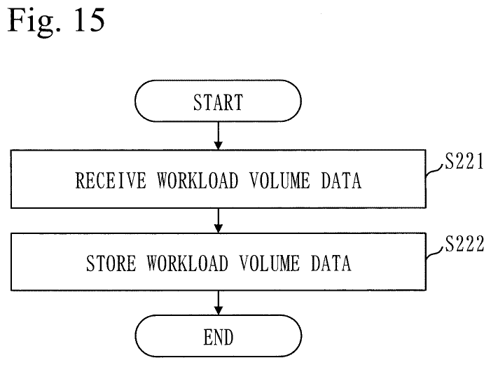

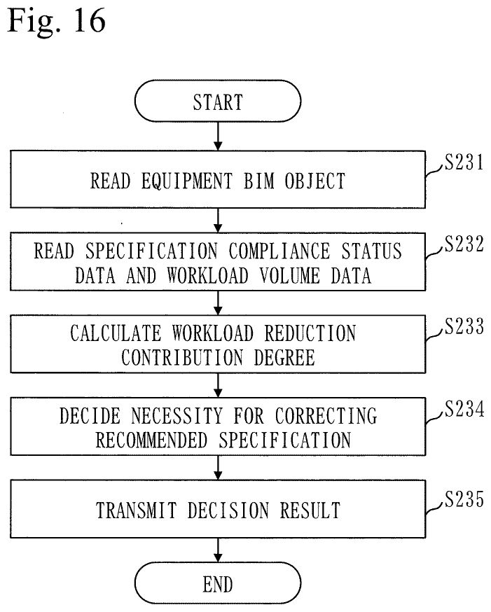

Next, a description will be given on an operation example of the data processing device 100 with reference to FIG. 14, FIG. 15, and FIG. 16.

It is assumed that the operation in FIG. 7 described in First Embodiment has been performed before the operations illustrated in FIG. 14, FIG. 15 and FIG. 16 are performed. In other words, it is assumed that the equipment BIM object 301 has been stored in the equipment BIM object storage unit 102 before the operations of FIG. 14, FIG. 15, and FIG. 16 are performed.

First, in Step S211 in FIG. 14, the specification compliance status data acquisition unit 107 receives the specification compliance status data 601 from the installation operator terminal 600, using the communication device 904.

Next, in Step S212, the acquired data storage unit 108 stores the specification compliance status data 601.

Note that the flow in FIG. 14 is performed each time the specification compliance status data 601 is transmitted from the installation operator terminal 600.

It is assumed that the acquired data storage unit 108 stores multiple pieces of specification compliance status data 601.

Next, in Step S221 in FIG. 15, the workload data acquisition unit 109 receives the workload volume data 701 from the maintenance provider terminal 700, using the communication device 904.

Next, in Step S222, the acquired data storage unit 108 stores the workload volume data 701.

Note that the flow in FIG. 15 is performed each time the workload volume data 701 is transmitted from the maintenance provider terminal 700.

It is assumed that the multiple pieces of workload volume data 701 are stored in the acquired data storage unit 108.

The flow in FIG. 16 is started when a request is made from the equipment manufacturer terminal 300.

Alternatively, the flow in FIG. 16 may be started when a specified timing to review the recommended specification arrives.

Furthermore, the flow in FIG. 16 may be started when the quantity of the specification compliance status data 601 stored in the acquired data storage unit 108 reaches a predetermined value.

In addition, the flow in FIG. 16 may be started when the quantity of the workload volume data 701 stored in the acquired data storage unit 108 reaches a predetermined value.

In Step S231 of FIG. 16, the decision unit 105 reads the equipment BIM object 301 from the equipment BIM object storage unit 102.

Next, in Step S232, the decision unit 105 reads specification compliance status data 601 and workload volume data 701 from the acquired data storage unit 108.

More specifically, the decision unit 105 reads the specification compliance status data 601 where an equipment ID corresponding to the equipment ID described in the equipment BIM object 301 read in Step S231 is described.

Similarly, the decision unit 105 reads the workload volume data 701 where an equipment ID corresponding to the equipment ID described in the equipment BIM object 301 read in Step S231 is described.

For example, in a case where the equipment BIM object 301 in FIG. 5 is read out in Step S231, the decision unit 105 reads the specification compliance status data 601 and the workload volume data 701 where an equipment ID corresponding to the equipment ID: indoor unit A1 is described. For example, the decision unit 105 reads the specification compliance status data 601 in FIG. 12 and the workload volume data 701 in FIG. 13.

Next, in Step S233, the decision unit 105 calculates a workload reduction contribution degree.

The workload reduction contribution degree is a value that indicates the degree to which the recommended specification contributes to the reduction of workload in installation of equipment.

Hereinafter, a calculation method of the workload reduction contribution degree will be described.

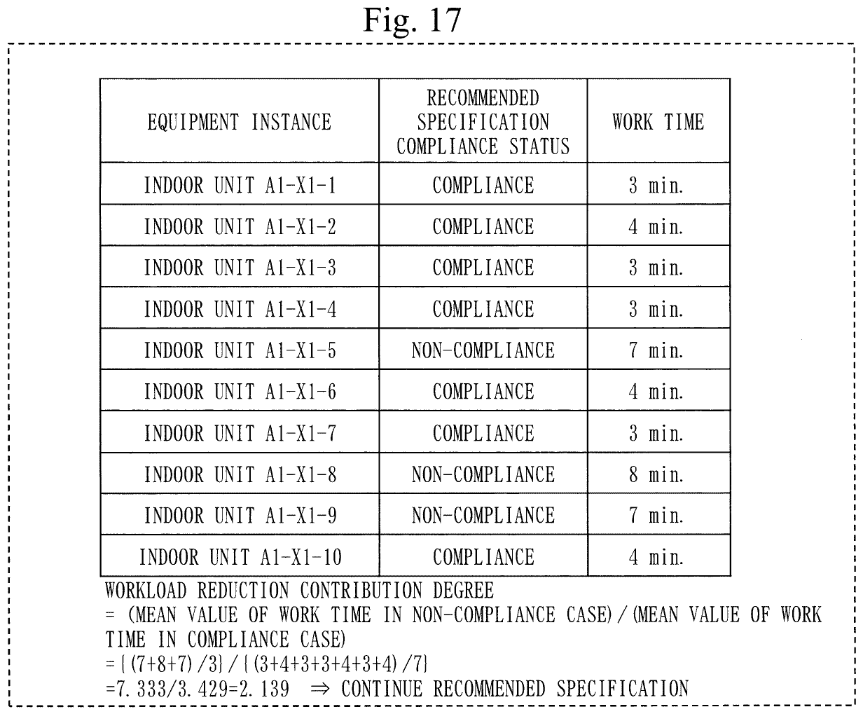

FIG. 17 indicates an example of the workload reduction contribution table generated by the decision unit 105 from the specification compliance status data 601 and the workload volume data 701.

In FIG. 17, the column of “equipment instance” indicates an equipment ID the decision unit 105 extracted from each of the multiple pieces of specification compliance status data 601 read in Step S232. That is, the column of “equipment instance” indicates each past case of installation. In the example of FIG. 17, the decision unit 105 reads 10 pieces of specification compliance status data 601 corresponding to 10 past cases of installation, in Step S232.

In the column of “recommended specification compliance status”, the compliance statuses with the recommended specification extracted from the decision unit 105 from each of the multiple pieces of specification compliance status data 601 read in Step S232 are indicated.

In the column of “work time”, the work times extracted by the decision unit 105 from each of the multiple pieces of workload volume data 701 read in Step S232 are indicated.

The decision unit 105 calculates the workload reduction contribution degree according to the following expression.

workload reduction contribution degree=(mean value of work times in non-compliance cases)/(mean value of work times in compliance cases)

In the example illustrated in FIG. 17, the workload reduction contribution degree=2.139 is obtained

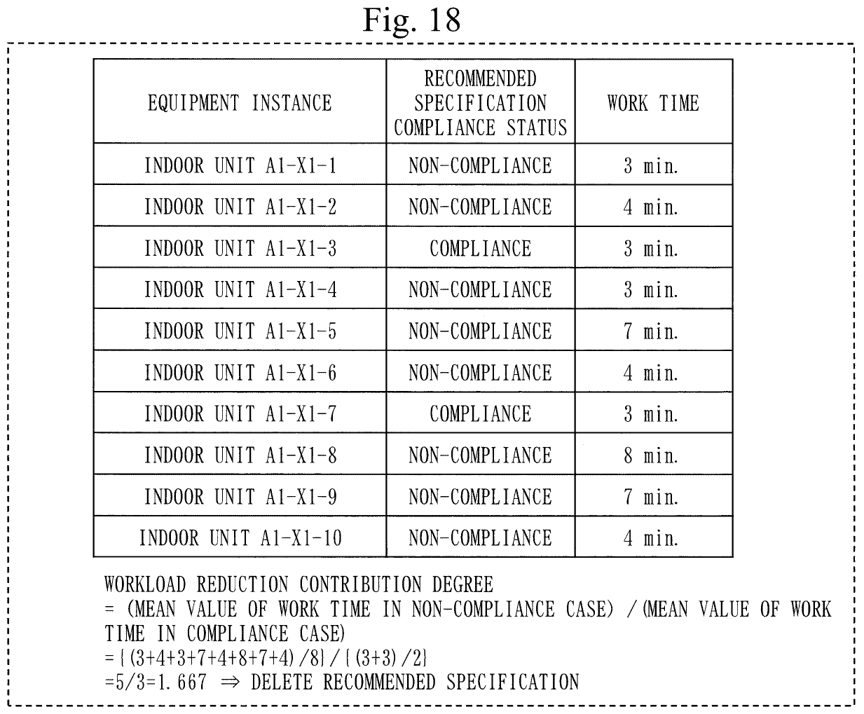

FIG. 18 indicates an example of another workload reduction contribution table.

In the example of FIG. 18, the recommended specification compliance status differs from that in FIG. 17. In the example of FIG. 18, there are more past cases of installation in non-compliance with the recommended specification than in the example of FIG. 17.

In the example indicated in FIG. 18, the workload reduction contribution degree=1.667 is obtained.

In Step S234 in FIG. 16, the decision unit 105 decides whether correction is necessary for the recommended specification.

In the present embodiment, the decision unit 105 decides whether to maintain or delete the recommended specification as the necessity for correcting the recommended specification.

Specifically, when the workload reduction contribution degree is equal to or more than a threshold value, the decision unit 105 decides that the recommended specification should be maintained. On the other hand, when the workload reduction contribution degree is less than the threshold value, the decision unit 105 decides that the recommended specification should be deleted.

Herein, the decision unit 105 uses “2.0” as the threshold value, for example.

In the example of FIG. 17, the workload reduction contribution degree is 2.139, and since it is equal to or larger than the threshold value, the decision unit 105 decides that the recommended specification should be continued.

On the other hand, in the example of FIG. 18, the workload reduction contribution degree=1.667, and since it is less than the threshold value, the decision unit 105 decides that the recommended specifications should be deleted.

Lastly, in Step S235, the output unit 106 transmits the decision result 160 by the decision unit 105 to the equipment manufacturer terminal 300, using the communication device 904.

The decision result 160 indicates a proposal for maintaining or deleting the recommended specification.

Furthermore, when there are multiple recommended specifications for one mandatory specification, the decision unit 105 calculates the workload reduction contribution degree for each recommended specification. Then, it is possible for the decision unit 105 to decide that the recommended specification with a workload reduction contribution degree equal to or larger than the threshold value should be maintained, and the recommended specification with a workload reduction contribution degree less than the threshold value should not be maintained.

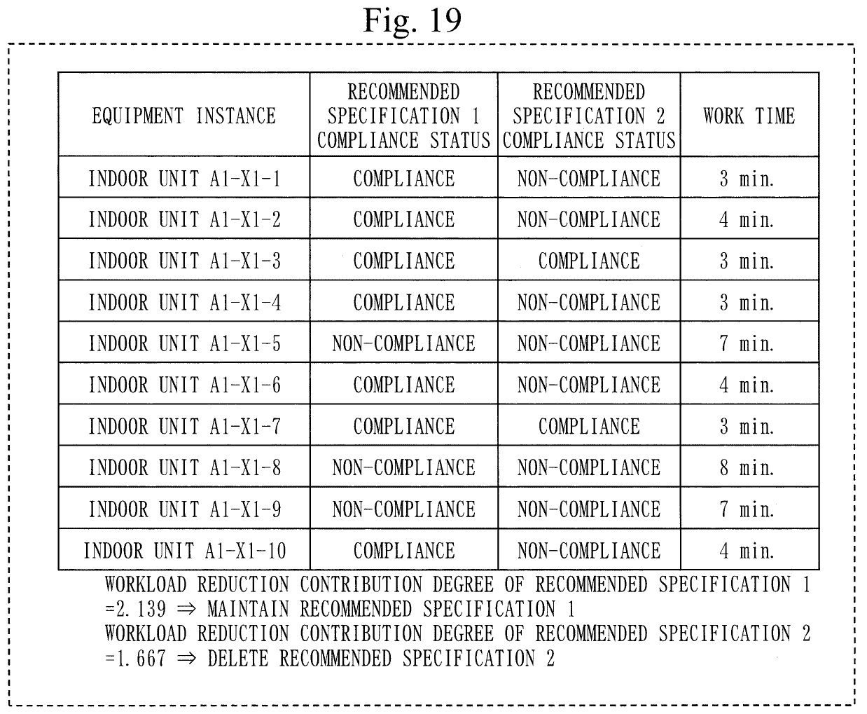

FIG. 19 indicates an example of a workload reduction contribution table when multiple recommended specifications exist.

In the example of FIG. 19, since the recommended specification 1 is equal to or larger than the threshold value, the decision unit 105 decides that the recommended specification 1 should be maintained. On the other hand, since the recommended specification 2 is less than the threshold value, the decision unit 105 decides that the recommended specification 2 should not be maintained.

Furthermore, in the present embodiment, the decision unit 105 decides the necessity for correcting the recommended specification based on the work time of the maintenance work.

Instead of this, the decision unit 105 may decide the necessity for correcting the recommended specification based on the work time of installation work for the equipment.

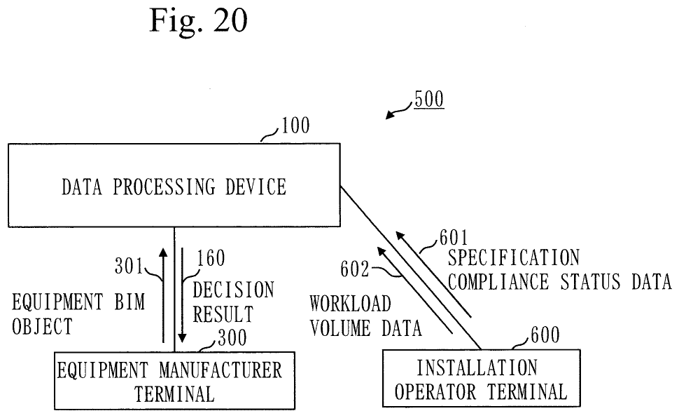

In this case, the configuration example indicated in FIG. 20 is considered instead of FIG. 10 as the configuration example of the data processing system 500, for example.

In the example of FIG. 20, the data processing device 100 receives the specification compliance status data 601 and workload volume data 602 from the installation operator terminal 600. The workload volume data 602 indicates the work time as with the workload volume data 701. In the workload volume data 602, the work time required for the installation work when the installation operator installs the equipment in a building is indicated for each combination of the building ID and the equipment ID.

In the data processing device 100, the specification compliance status data acquisition unit 107 illustrated in FIG. 11 receives the specification compliance status data 601 from the installation operator terminal 600, and the workload data acquisition unit 109 receives the workload volume data 602 from the installation operator terminal 600.

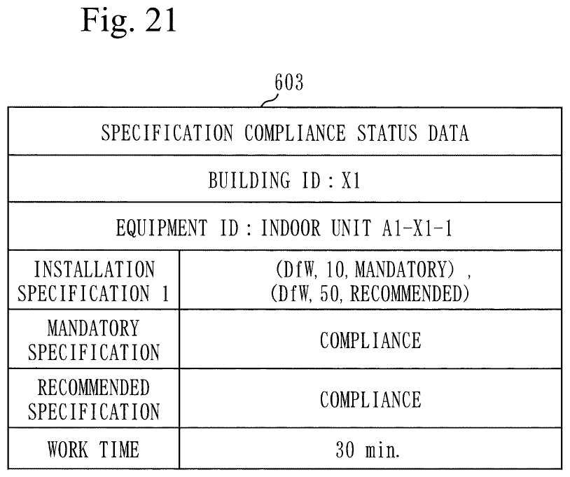

Although the installation operator terminal 600 is assumed to transmit both the specification compliance status data 601 and the workload volume data 602 in FIG. 20, the installation operator terminal 600 may transmit specification compliance status data 603 which is a combination of the specification compliance status data 601 and the workload volume data 602 as illustrated in FIG. 21. In this case, in the data processing device 100, the specification compliance status data acquisition unit 107 receives the specification compliance status data 603 instead of the specification compliance status data 601. Then, the specification compliance status data acquisition unit 107 stores the specification compliance status data 603 in the acquired data storage unit 108.

In this case, it is possible to omit the workload data acquisition unit 109 from the configuration of the data processing device 100.

In addition, it is possible to omit the flow of FIG. 15.

Further, in the present embodiment, the decision unit 105 calculates the workload reduction contribution degree, using the mean value of work times. The decision unit 105 may calculate the workload reduction contribution degree, using the total value of work times instead of using the mean value of work times.

In other words, the decision unit 105 may calculate the workload reduction contribution degree as follows.

workload reduction contribution degree=(total value of work times in non-compliance cases)/(total value of work times in compliance cases)

In addition, although the decision unit 105 decides the necessity for correcting the recommended specification in the present embodiment, the decision unit 105 may also decide the necessity for correcting the mandatory specification.

The method for the decision unit 105 to decide the necessity for correcting the mandatory specification is realized by replacing “recommended specification” in the description of the present embodiment with “mandatory specification”.

Further, in the present embodiment, the specification compliance status data acquisition unit 107 acquires the specification compliance status data 601 from the installation operator terminal 600. Instead of this, the specification compliance status data acquisition unit 107 may acquire the decision result 150 described in First Embodiment as the specification compliance status data 601. The decision result 150 in First Embodiment indicates decision results on whether the equipment is installed in the building in compliance with the mandatory specification, and on whether the equipment is installed in the building in compliance with the recommended specification. Therefore, the decision unit 105 may use the decision result 150 as the specification compliance status data 601.

When the data processing device 100 in First Embodiment and the data processing device 100 in Second Embodiment are configured as separate devices, the specification compliance status data acquisition unit 107 acquires the decision result 150 from the decision unit 105 of the data processing device 100 in First Embodiment.

When the data processing device 100 in First Embodiment and the data processing device 100 in Second Embodiment are configured as the same device, the data processing device 100 includes the configurations illustrated in FIG. 2 and FIG. 11. Further, the specification compliance status data acquisition unit 107 acquires the decision result 150 from the decision unit 105 illustrated in FIG. 2.

### Description of Effect of Embodiment

In the above, it is possible to decide the usefulness of installation specifications from the perspective of reducing the workload of maintenance work for equipment or reducing the workload of installation work for equipment according to the present embodiment.

### Third Embodiment

In the present embodiment, a description will be given on an example where the necessity for correcting the recommended specification is decided in a different manner from Second Embodiment.

In the present embodiment, a description will be given mainly on the differences with Second Embodiment.

Note that matters not described below are the same as those in Second Embodiment.

Furthermore, in the following, a description will be given by using the indoor unit as an example of the equipment.

A configuration example of the data processing system 500 according to the present embodiment is as illustrated in FIG. 10.

Further, an example of the functional configuration of the data processing device 100 according to the present embodiment is as illustrated in FIG. 11.

Moreover, the data processing device 100 according to the present embodiment performs operations as indicated in FIG. 14 and FIG. 15.

In the present embodiment, the decision unit 105 performs Step S231 and Step S323 in FIG. 16, whereas Step S233 is not performed. Further, the decision unit 105 performs Step S234 in FIG. 16, where the necessity for correcting the recommended specification is decided in a manner different from Second Embodiment.

Specifically, in the present embodiment, the decision unit 105 examines the independence of the work time in the past cases of installation where the equipment is installed in non-compliance with the recommended specifications and the work time in the past cases of installation where the equipment is installed in compliance with the recommended specifications, in Step S234.

Then, when the hypothesis is rejected (independence is denied), the decision unit 105 decides to continue the recommended specification. On the other hand, when the hypothesis is not rejected (independence is not denied), the decision unit 105 decides to delete the recommended specification.

In the present embodiment, the workload reduction contribution degree is a p value, and the threshold value is a significance level. However, since it is assumed that the smaller the p value is, the greater the contribution to the reduction of the workload is, the decision unit 105 decides to delete the recommended specification in a case of “p value>significance level”. Further, the decision unit 105 may handle “1/p value” as the workload reduction contribution degree, and “1/significance level” as the threshold value.

Subsequently, Step S235 in FIG. 16 is performed as with Second Embodiment.

### Description of Effect of Embodiment

It is possible to decide the usefulness of the installation specifications from the perspective of reducing the workload of maintenance work for the equipment or the workload of the installation work for the equipment according to the present embodiment as well.

### Fourth Embodiment

In Second Embodiment and Third Embodiment, the decision unit 105 only decides whether to maintain or delete the recommended specification.

In the present embodiment, a description will be given on an example where the decision unit 105 selects a correction value for the recommended specification when the decision unit 105 decides that correction of the recommended specification is necessary.

In the present embodiment, a description will be given mainly on the differences from Second Embodiment.

Furthermore, matters not described below are the same as those in Second Embodiment.

Additionally, in the following, a description will be given using the indoor unit as an example of the equipment.

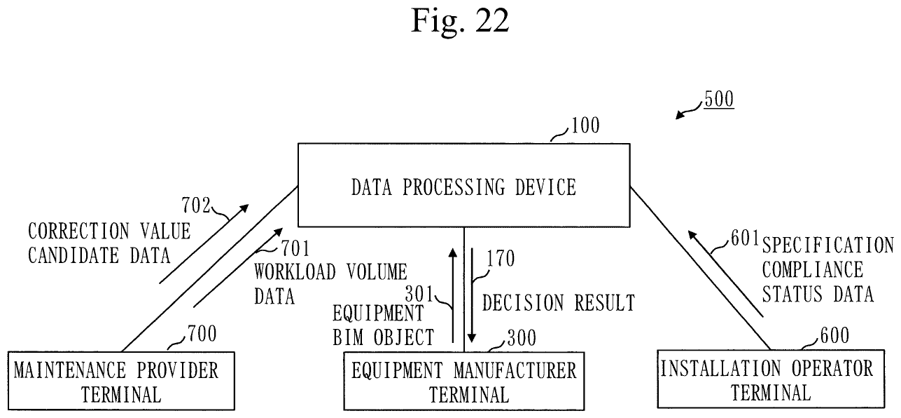

FIG. 22 illustrates a configuration example of the data processing system 500 according to the present embodiment.

In the present embodiment, the maintenance provider terminal 700 transmits correction value candidate data 702 to the data processing device 100 for each past case of installation.

In the present embodiment, the data processing device 100 transmits a decision result 170 to the equipment manufacturer terminal 300. The decision result 170 may include a correction value for the recommended specification.

Elements other than the correction value candidate data 702 and the decision result 170 are the same as those illustrated in FIG. 10.

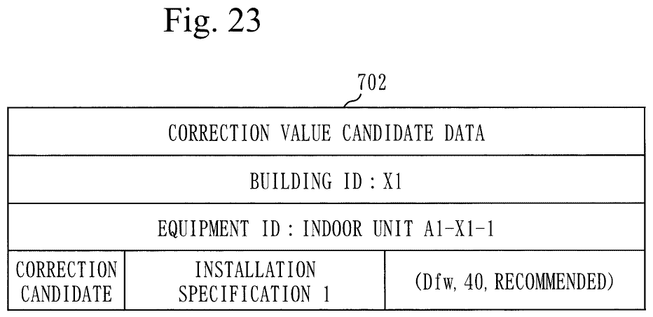

FIG. 23 illustrates an example of the correction value candidate data 702.

In the correction value candidate data 702, the building ID is the same as that described in Second Embodiment. Additionally, in the correction value candidate data 702, equipment IDs similar to the equipment IDs of the equipment BIM data 401 and the specification compliance status data 601 are set.

The correction value candidate is a candidate for the correction value for the parameter value of the recommended specification. In the example illustrated in FIG. 23, (Dfw, 40, Recommended) is indicated as the correction value candidate for (Dfw, 50, Recommended) which is the recommended specification in the installation specification 1 indicated in FIG. 5. In other words, “40” is indicated as a correction value candidate of the parameter value “50”.

Although “(Dfw, 40, Recommended)” is indicated as the correction value candidate for the sake of easy understanding in FIG. 23, “40” may be simply indicated as the correction value candidate.

The maintenance provider may indicate the correction value candidate in the correction value candidate data 702 as a correction request for the parameter value of the recommended specification. That is, when the maintenance provider desires to correct the parameter value of the recommended specification, the maintenance provider indicates the correction value candidate in the correction value candidate data 702. The maintenance provider may indicate as the correction candidate both a numerical value (for example, 40 cm) closer to the mandatory specification and a numerical value (for example, 60 cm) farther from the mandatory specification than the present recommended specification.

When the maintenance provider does not desire to correct the parameter value of the recommended specification, the maintenance provider indicates “none”, for example, in the column of the correction candidate.

In the present embodiment, the data processing device 100 receives multiple pieces of correction value candidate data 702 for multiple past cases of installation.

Furthermore, when the data processing device 100 decides that correction for the recommended specification is necessary, the data processing device 100 selects a correction value for the recommended specification from multiple correction candidates included in the multiple pieces of correction value candidate data 702. Then, the data processing device 100 transmits the decision result 170 to the equipment manufacturer terminal 300. When the data processing device 100 selects the correction value, the correction value is included in the decision result 170.

The equipment manufacturer considers correcting the parameter value of the recommended specification to the correction value when the correction value for the recommended specification is indicated in the decision result 170.

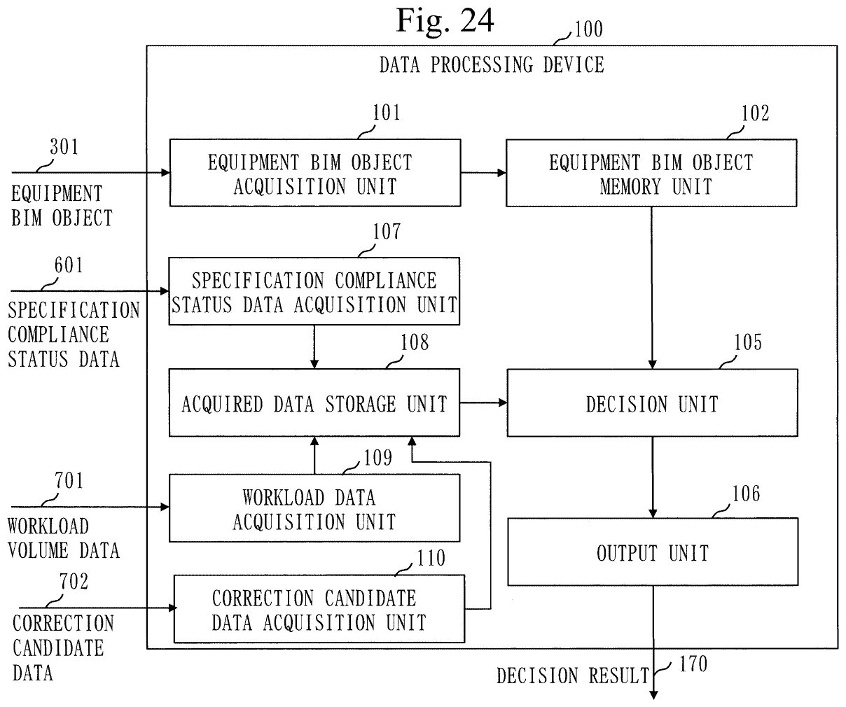

FIG. 24 illustrates an example of the functional configuration of the data processing device 100 according to the present embodiment.

In FIG. 24, a correction value candidate data acquisition unit 110 is added compared to FIG. 11.

Additionally, the output unit 106 outputs the decision result 170.

The correction value candidate data acquisition unit 110 receives the correction value candidate data 702, using the communication device 904. Then, the correction value candidate data acquisition unit 110 stores the correction value candidate data 702 received, in the acquired data storage unit 108.

In the present embodiment, when the decision unit 105 decides that correction for the recommended specification is necessary, the decision unit 105 selects a correction value candidate value from the multiple correction candidate values included in the multiple pieces of correction value candidate data 702 as the correction value for the recommended specification.

For instance, the decision unit 105 counts the number of times each correction value candidate appears in the multiple pieces of correction value candidate data 702. Then, the decision unit 105 selects a correction value candidate from the multiple correction value candidates based on the result of the counting, as the correction value for the recommended specification.

Then, the data processing device 100 transmits the decision result 170 to the equipment manufacturer terminal 300. When the data processing device 100 selects a correction value, the correction value is included in the decision result 170.

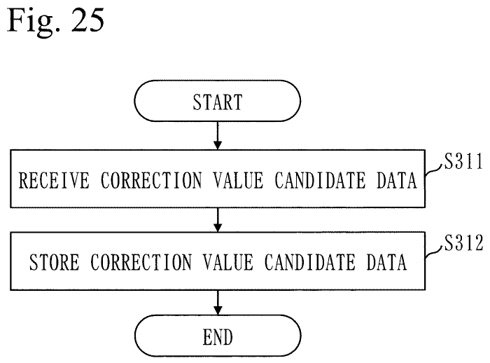

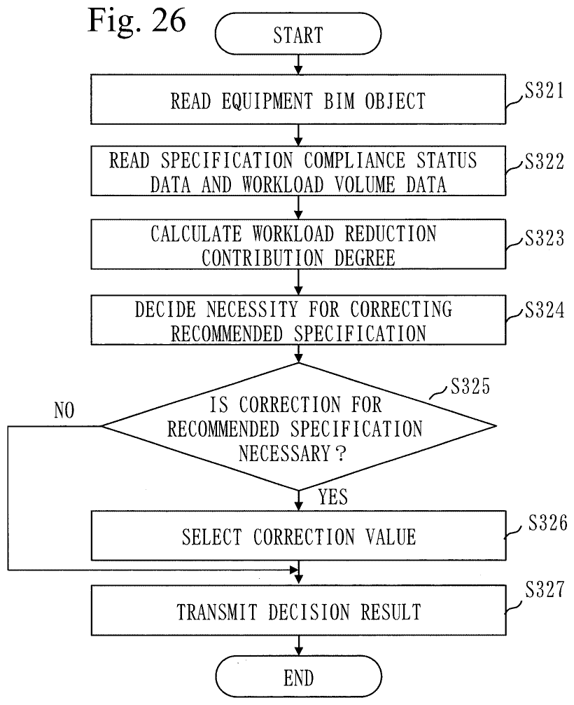

Furthermore, operation examples of the data processing device 100 according to the present embodiment is as illustrated in FIG. 14, FIG. 15, FIG. 25 and FIG. 26.

FIG. 14 and FIG. 15 are the same as those described in Second Embodiment. Therefore, the description of FIG. 14 and FIG. 15 is omitted.

In FIG. 25, the correction value candidate data acquisition unit 110 receives the correction value candidate data 702 from the maintenance provider terminal 700, using the communication device 904, in Step S311

Next, in Step S312, the acquired data storage unit 108 stores the correction value candidate data 702.

In FIG. 26, Step S321 through Step S324 are the same as Step S231 through Step S234 in FIG. 16. Therefore, the description of these is omitted.

When correction for the recommended specification is necessary (YES in Step S325) as a result of decision on the necessity for correcting the recommended specification by the decision unit 105 in Step S324, the process proceeds to Step S326.

The case where the correction for the recommended specification is necessary refers to the case where the decision unit 105 decides to delete the recommended specification in Step S324.

In Step S326, the decision unit 105 selects a correction value for the parameter value of the recommended specification.

Specifically, the decision unit 105 reads the multiple pieces of correction value candidate data 702 from the acquired data storage unit 108. Then, the decision unit 105 counts the number of times each correction value candidate appears in the multiple pieces of correction value candidate data 702. Furthermore, the decision unit 105 selects a correction value candidate from among the multiple correction value candidates based on the result of counting, as the correction value for the recommended specification.

Then, in Step S327, the output unit 106 transmits the decision result 170 by the decision unit 105 to the equipment manufacturer terminal 300, using the communication device 904.

As described above, when the decision unit 105 selects a correction value, the correction value is included in the decision result 170.

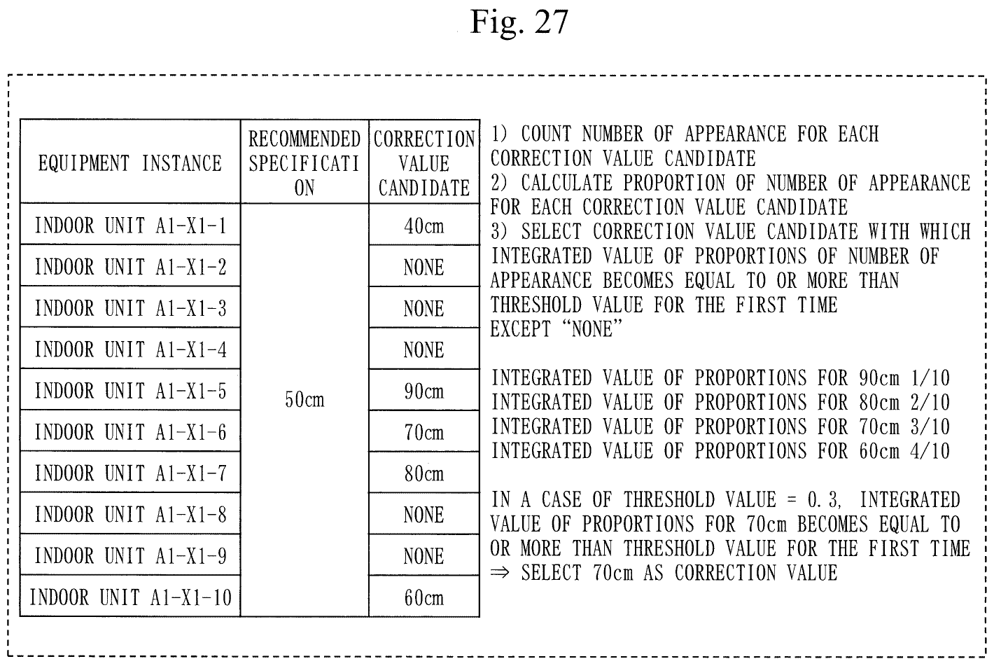

FIG. 27 indicates an example of the correction value candidate table generated by the decision unit 105.

With reference to FIG. 27, a description will be given on a method in which the decision unit 105 selects a correction value in Step S326.

In FIG. 27, the column of “equipment instance” is the same as that indicated in FIG. 17. The decision unit 105 extracts the equipment ID from the specification compliance status data 601 in FIG. 12, and generates the column of “equipment instance”.

In the column of “recommended specification”, the recommended specification “50 cm” indicated in the equipment BIM object 301 in FIG. 5 is indicated. The decision unit 105 extracts the parameter value of the recommended specification from the equipment BIM object 301, and generates the column of “recommended specification”.

In the column of “correction value candidate”, the correction value candidates extracted by the decision unit 105 from the multiple pieces of correction value candidate data 702 are indicated. The decision unit 105 extracts the correction value candidates from the correction value candidate data 702 in FIG. 23, and generates the column of “correction value candidate”.

Then, the decision unit 105 selects the correction value for the recommended specification in the following procedure.

1) The decision unit 105 counts the number of times (hereinafter referred to as the number of appearances) the correction value candidates appear in the correction value candidate data 702 for each correction value candidate.

In the example of FIG. 27, the number of appearances for each of 90 cm, 80 cm, 70 cm, 60 cm and 40 cm is “1”. Further, the number of appearances for “none” is “5”.

2) Next, the decision unit 105 calculates the proportion of the number of appearances of the correction value candidates to the total number of appearances, for each correction value candidate.

In the example of FIG. 27, the proportion of the number of appearances for each of 90 cm, 80 cm, 70 cm, 60 cm and 40 cm is “1/10”. Further, the number of appearances for “none” is “5/10”.

3) Next, the decision unit 105 integrates the proportions of the number of appearances of the correction value candidates in descending order, and selects a correction value candidate with which the integrated value becomes equal to or larger than the threshold value for the first time except “none” as the correction value for the recommended specification.

In the example of FIG. 27, the decision unit 105 uses “0.3” as the threshold value.

Then, in the example of FIG. 27, the integrated value obtained by integrating the proportion of the number of appearances for 90 cm, the proportion of the number of appearances for 80 cm, and the proportion of the number of appearances for 70 cm is (1/10+1/10+1/10)=3/10. In FIG. 27, the integrated value of the proportion of the number of appearances for 90 cm, the proportion of the number of appearances for 80 cm, and the proportion of the number of appearances for 70 cm is written as “integrated value of the proportion for 70 cm”. In the example of FIG. 27, “integrated value of the proportion for 70 cm” becomes equal to or larger than the threshold value for the first time.

Therefore, the decision unit 105 selects 70 cm as the correction value for the recommended specification.

In the example of FIG. 27, the decision unit 105 integrates the proportions of the number of appearances of the correction value candidates in descending order. Alternatively, the decision unit 105 may integrate the proportions of the number of appearances of the correction value candidates in ascending order, and may select the correction value candidate with which the integrated value becomes equal to or larger than the threshold for the first time as the correction value for the recommended specification.

Furthermore, the decision unit 105 may select the correction value candidate with the highest number of appearances among the correction value candidates except the correction value candidate “none”, as the correction value for the recommended specification.

In addition, although the decision unit 105 selects a correction value for the recommended specification in the present embodiment, a correction value for the mandatory specification may also be selected.

The method by which the decision unit 105 selects the correction value for the mandatory specification is realized by replacing “recommended specification” in the description in the present embodiment with “mandatory specification”.

### Description of Effect of Embodiment

According to the present embodiment, it is possible to reflect the parameter value demanded by a maintenance provider in the installation specification.

### Fifth Embodiment

In the present embodiment, a description will be given on an example where the decision unit 105 selects the correction value for the recommended specification in a manner different from that in Fourth Embodiment 4.

In the present embodiment, a description will be given mainly on the difference from Fourth Embodiment.

Note that matters not described below are the same as those in Fourth Embodiment.

Furthermore, a description will be given hereinafter by using the indoor unit as an example of the equipment.

A configuration example of the data processing system 500 according to the present embodiment is as illustrated in FIG. 22.

Further, an example of the function configuration of the data processing device 100 according to the present embodiment is as illustrated in FIG. 24.

Furthermore, operation examples of the data processing device 100 according to the present embodiment are as indicated in FIG. 14, FIG. 15, FIG. 25 and FIG. 26.

In the present embodiment, the method to select the correction value in Step S326 in FIG. 26 differs from that in Fourth Embodiment.

In the present embodiment, in Step S326, when the decision unit 105 reads the multiple pieces of correction value candidate data 702 from the acquired data storage unit 108, the decision unit 105 decides whether the equipment is installed in compliance with the recommended specification in the past case of installation associated with the correction value candidate data 702, for each piece of the correction value candidate data 702. In other words, the decision unit 105 decides the compliance status of the recommended specification in the specification compliance status data 601 where the same equipment ID as the equipment ID of the correction value candidate data 702 is set, for each piece of the correction value candidate data 702.

Furthermore, the decision unit 105 counts the number of times the equipment is installed in compliance with the installation specifications in the past case of installation associated, for each correction value candidate.

Moreover, based on the result of counting, the decision unit 105 selects a correction value candidate from among the multiple correction value candidates, as the correction value for the recommended specification.

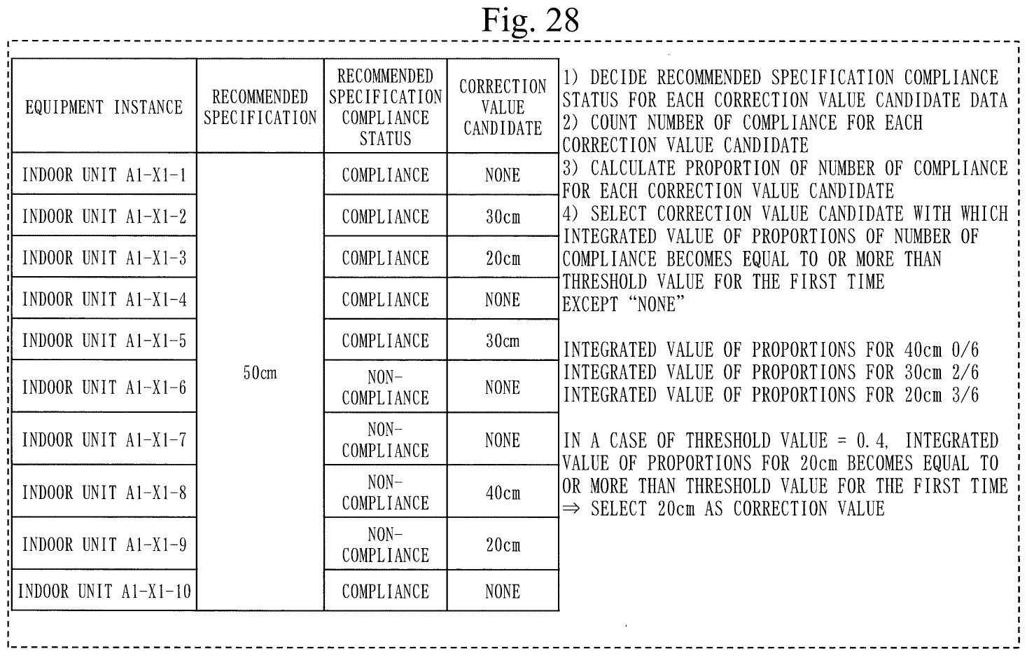

FIG. 28 indicates an example of a correction value candidate table generated by the decision unit 105 according to the present embodiment.

In FIG. 28, “equipment instance”, “recommended specification” and “correction value candidate” are the same as those indicated in FIG. 27. However, the numerical values in “correction value candidate” are different from those in FIG. 27.

In the column of “recommended specification compliance status”, the compliance status for the recommended specification decided for each piece of the correction value candidate data 702 by the decision unit 105 is indicated.

With reference to FIG. 28, a description will be given on a method by which the decision unit 105 selects a correction value in Step S326.

It should be noted here that the decision unit 105 is assumed to generate a correction value candidate table as with FIG. 27 by the procedure described in Fourth Embodiment. That is, the decision unit 105 is assumed to generate items other than “recommended specification compliance status” in the correction value candidate table in FIG. 28.

The decision unit 105 selects the correction value for the recommended specification in the following procedure.

1) The decision unit 105 decides the recommended specification compliance status for each piece of the correction value candidate data 702, that is, for each past case of installation. The decision unit 105 extracts the compliance status with the recommended specification from the specification compliance status data 601 in FIG. 12, and generates the column of “recommended specification compliance status”.

It is here assumed that the recommended specification compliance status indicated in FIG. 28 is obtained.

2) Next, the decision unit 105 counts the number of times (hereinafter referred to as the number of times of compliance) the equipment is installed in compliance with the recommended specification, for each correction value candidate.

In the example of FIG. 28, the number of times of compliance for 40 cm is “0”. Further, the number of times of compliance for 30 cm is “2”. Further, the number of times of compliance for 20 cm is “1”. The number of times of compliance for “none” is “3”.

3) Next, the decision unit 105 calculates the proportion of the number of times of compliance of the correction value candidate to the total number of times of compliance, for each correction value candidate.

In the example of FIG. 28, the proportion of the number of times of compliance for 40 cm is “0/6”. Further, the proportion of the number of times of compliance for 30 cm is “2/6”. The proportion of the number of times of compliance for 20 cm is “1/6”. The proportion of the number of times of compliance for “none” is “3/6”.

4) Next, the decision unit 105 integrates the proportions of the number of times of compliance of the candidate correction values in descending order, and selects the correction value candidate with which the integrated value becomes equal to or larger than the threshold value for the first time except “none”, as the correction value for the recommended specification.

In the example of FIG. 28, the decision unit 105 uses “0.4” as the threshold value.

Then, in the example of FIG. 28, the integrated value obtained by integrating the proportion of the number of times of compliance for 40 cm, the proportion of the number of times of compliance for 30 cm, and the proportion of the number of times of compliance for 20 cm is (0/6+2/6+1/6)=3/6. In FIG. 28, the integrated value of the proportion of the number of times of compliance for 40 cm, the proportion of the number of times of compliance for 30 cm, and the proportion of the number of times of compliance for 20 cm is written as “integrated value of the proportion for 20 cm”. In the example of FIG. 28, “integrated value of the proportion for 20 cm” becomes equal to or larger than the threshold value for the first time.

Therefore, the decision unit 105 selects 20 cm as the correction value for the recommended specification.

In the example of FIG. 28, the decision unit 105 integrates the proportions of the number of times of compliance of the correction value candidates in descending order. Alternatively, the decision unit 105 may integrate the proportions of the number of times of compliance of the correction value candidates in ascending order, and may select the correction value candidate with which the integrated value becomes equal to or larger than the threshold value for the first time as the correction value for the recommended specification.

In addition, the decision unit 105 may select the correction value candidate with the highest number of times of compliance among the correction value candidates except the correction value candidate “none”, as the correction value for the recommended specification.

Furthermore, although the decision unit 105 selects the correction value for the recommended specification in the present embodiment, the decision unit 105 may select a correction value for the mandatory specification.

The method by which the decision unit 105 selects the correction value for the mandatory specification is realized by replacing “recommended specification” in the description of the present embodiment with “mandatory specification”.

### Description of Effect of Embodiment

According to the present embodiment, it is possible to reflect the parameter value demanded by the maintenance provider in the installation specification, considering the compliance status with the installation specification in the past case of installation.

### Sixth Embodiment

In the present embodiment, a description will be given on an example where the decision unit 105 selects a correction value for the recommended specification in a different manner than Fourth Embodiment.

In the present embodiment, a description will be given mainly on the differences with Fourth Embodiment.

Note that matters not described below are the same as those in Fourth Embodiment.

Further, a description will be given hereinafter by using the indoor unit as an example of the equipment.

A configuration example of the data processing system 500 according to the present embodiment is as illustrated in FIG. 22.

Further, an example of the functional configuration of the data processing device 100 according to the present embodiment is as illustrated in FIG. 24.

Furthermore, operation examples of the data processing device 100 according to the present embodiment are as illustrated in FIG. 14, FIG. 15, FIG. 25 and FIG. 26.

In the present embodiment, a method to select a correction value in Step S326 in FIG. 26 is different from that in Fourth Embodiment.

In the present embodiment, the decision unit 105 reads the multiple pieces of correction value candidate data 702 from the acquired data storage unit 108.

Further, the decision unit 105 analyzes the correlation between the correction value candidates and workload volumes in multiple past cases of installation.

Specifically, the decision unit 105 first obtains the workload volume (work time) in the past case of installation associated with the correction value candidate data 702. That is, the decision unit 105 obtains the work time from the workload volume data 701 set with the same equipment ID as the equipment ID of the correction value candidate data 702, for each piece of the correction value candidate data 702. Next, the decision unit 105 plots a point corresponding to the relation between the correction value candidate and the work time in each past case of installation on a two-dimensional graph. Further, the decision unit 105 analyzes the correlation between the correction value candidates and the working times, using the two-dimensional graph.

Then, based on the analysis result, the decision unit 105 selects a correction value candidate from the multiple correction value candidates as the correction value for the recommended specification. Specifically, the decision unit 105 selects the correction value candidate at a position where the trend of the correlation between the correction value candidates and the working times changes, as the correction value for the recommended specification.

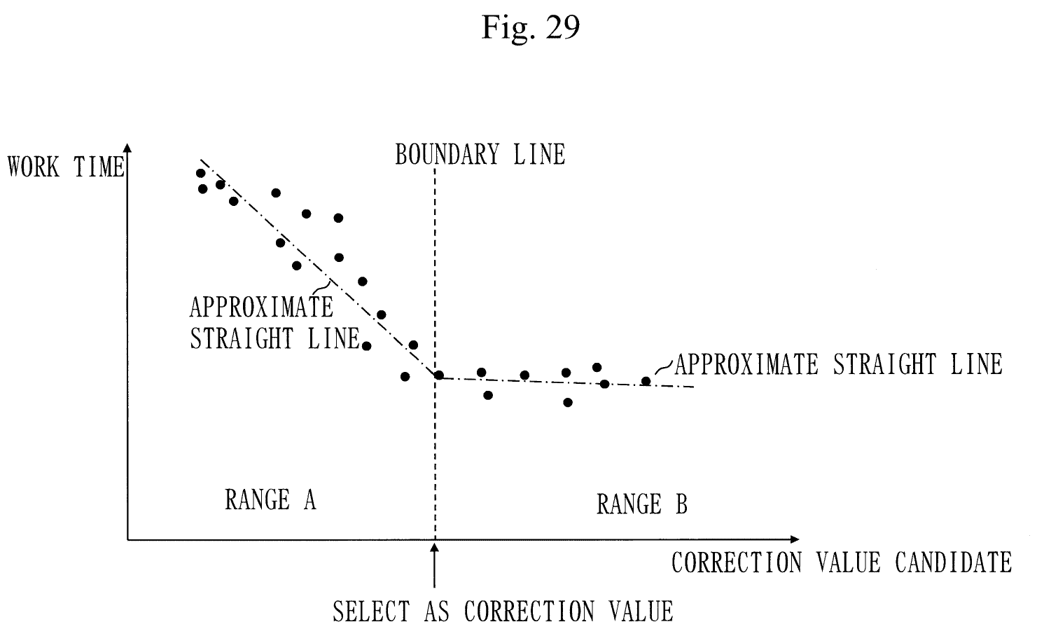

FIG. 29 is an example of a two-dimensional graph that expresses the correlation between the correction value candidates and the working times.

With reference to FIG. 29, a description will be given on a method by which the decision unit 105 selects a correction value in Step S326

In the two-dimensional graph in FIG. 29, the horizontal axis represents the correction value candidate, and the vertical axis represents the work time being the workload volume.

As previously described, the decision unit 105 plots points corresponding to pairs of the correction value candidates from the correction value candidate data 702 with the same equipment ID and the work times from the workload volume data 701 on the two-dimensional graph.

FIG. 29 illustrates a state where plotting by the decision unit 105 is completed.

The decision unit 105 extracts a correction value candidate located at a position where the trend of correlation between the correction value candidates and the work times in the two-dimensional graph changes.

Specifically, the decision unit 105 divides the area in the two-dimensional graph into a range A and a range B. Then, the decision unit 105 sets an approximate straight line that approximates the distribution in the range A. Similarly, the decision unit 105 sets in the range B an approximate straight line that approximates the distribution in the range B.

The decision unit 105 repeats the processing to set the approximate straight lines in the range A and the range B by changing the boundary line between the range A and the range B.

Then, the decision unit 105 selects a correction value candidate located on the boundary line where the absolute value of the ratio between the inclination of the approximate straight line in the range A and the inclination of the approximate straight line in the range B is the largest, as the correction value for the recommended specification.

In the above, the description has been given on the example where the decision unit 105 analyzes the correlation between the correction value candidates and the work times from the maintenance provider terminal 700, and selects the correction value for the recommended specification.

Instead of this, the decision unit 105 may analyze the correlation between the correction value candidates and the work times from the installation operator terminal 600, and select the correction value for the recommended specification.

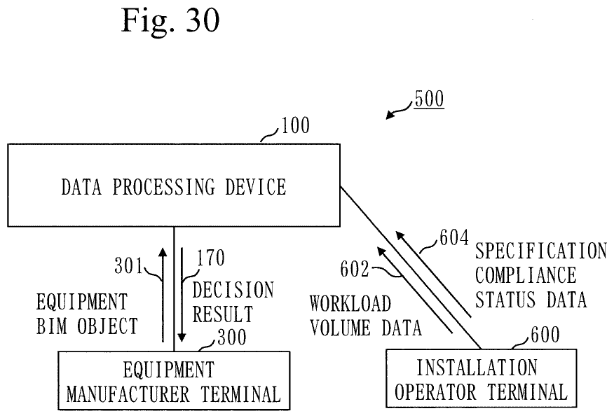

The configuration example of the data processing system 500 in this case is illustrated in FIG. 30.

In FIG. 30, the installation operator terminal 600 transmits the specification compliance status data 604 and the workload volume data 602.

As described above, in the workload volume data 602, the work times required for the installation work of the equipment by the installation operator are indicated for each combination of the building ID and the equipment ID.

In the data processing device 100, the specification compliance status data acquisition unit 107 receives the specification compliance status data 604. Further, the workload data acquisition unit 109 receives the workload volume data 602.

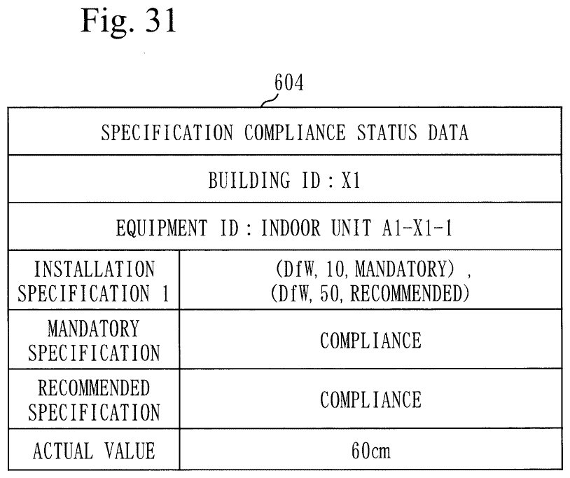

FIG. 31 illustrates an example of the specification compliance status data 604.

In the specification compliance status data 604, elements other than the actual values are the same as the elements with the same names in the specification compliance status data 601 as illustrated in FIG. 12.

The actual values are values that are actually applied in the installation work of equipment. The example of FIG. 31 illustrates that the indoor unit is installed 60 cm away from the wall when the indoor unit is installed by the installation operator. The decision unit 105 uses the actual values indicated in the specification compliance status data 604 as correction value candidates.

In other words, the decision unit 105 plots the point corresponding to the pair of the actual value of the specification compliance status data 604 and the work time from the workload volume data 602 to which the same equipment IDs are set, on a two-dimensional graph, as exemplified in FIG. 29.

Then, the decision unit 105 selects the actual value at the position where the trend of the correlation between the actual values and the work times on the two-dimensional graph changes, as the correction value for the recommended specification.

Additionally, the decision unit 105 may analyze the correlation between the correction value candidates from the maintenance provider terminal 700 and the work times from the installation operator terminal 600, and may select the correction value for the recommended specification. In this case, the decision unit 105 plots the point corresponding to the pair of the correction value candidate from the correction value candidate data 702 and the work time from the workload volume data 602 to which the same equipment IDs are set, on a two-dimensional graph.

Furthermore, the decision unit 105 may analyze the correlation between the actual values from the installation operator terminal 600 and the work times from the maintenance provider terminal 700, and may select the correction value for the recommended specification. In this case, the decision unit 105 plots the point corresponding to the pair of the actual value from the specification compliance status data 604 and the work time from the workload volume data 701 to which the same equipment IDs are set, on a two-dimensional graph.

Furthermore, although the decision unit 105 selects the correction value for the recommended specification in the present embodiment, the decision unit 105 may also select a correction value for the mandatory specification.

The method by which the decision unit 105 selects the correction value for the mandatory specification is realized by replacing “recommended specification” in the description in the present embodiment with “mandatory specification”.

### Description of Effect of Embodiment

According to the present embodiment, it is possible to select a suitable correction value for the installation specification based on the correlation between the workload volumes in an installation work or a maintenance work, and the correction value candidates derived from the installation work or the maintenance work.

Whereas the above describes First Embodiment through Sixth Embodiment, two or more of these embodiments may be combined and implemented.

Alternatively, one of these embodiments may be partially implemented.

Otherwise, two or more of these embodiments may be partially combined and implemented.

Further, the configurations and procedures described in these embodiments may be altered as needed.

### Supplementary Description of Hardware Configuration

Lastly, a supplementary explanation of the hardware configuration of the data processing device 100 will be given.

The processor 901 illustrated in FIG. 3 is an IC (Integrated Circuit) to perform processing.

The processor 901 may be a CPU (Central Processing Unit), a DSP (Digital Signal Processor), and the like.

The main memory unit 902 illustrated in FIG. 3 is a RAM (Random Access Memory).

The auxiliary storage device 903 illustrated in FIG. 3 is a ROM (Read Only Memory), a flash memory, an HDD (Hard Disk Drive), and the like.

The communication device 904 illustrated in FIG. 3 is an electronic circuit that executes data communication processing.

The communication device 904 is, for example, a communication chip or a NIC (Network Interface Card).

Additionally, the auxiliary storage device 903 also stores the OS (Operating System).

Then, at least a part of the OS is executed by the processor 901.

While the processor 901 executes at least part of the OS, the processor 901 executes programs that realize the functions of the equipment BIM object acquisition unit 101, the architecture BIM data acquisition unit 103, the equipment BIM data acquisition unit 104, the decision unit 105 and the output unit 106.

By executing the OS, the processor 901 performs task management, memory management, file management, and communication control, and the like.

Moreover, at least one of the information, data, signal values, and variable values that indicate the results of the processing by the equipment BIM object acquisition unit 101, the architecture BIM data acquisition unit 103, the equipment BIM data acquisition unit 104, the decision unit 105, and the output unit 106 is stored in at least one of the main memory unit 902, the auxiliary storage device 903, and registers and a cache memory in the processor 901.

Furthermore, the programs that realize the functions of the equipment BIM object acquisition unit 101, the architecture BIM data acquisition unit 103, the equipment BIM data acquisition unit 104, the decision unit 105, and the output unit 106 may be stored on a portable recording medium such as a magnetic disk, a flexible disk, an optical disc, a compact disc, a Blu-ray (registered trademark) disk, a DVD, and the like. Further, it is permissible to distribute the portable recording medium on which the programs that realize the functions of the equipment BIM object acquisition unit 101, the architecture BIM data acquisition unit 103, the equipment BIM data acquisition unit 104, the decision unit 105, and the output unit 106 are stored.

Further, at least any “unit” of the equipment BIM object acquisition unit 101, the architecture BIM data acquisition unit 103, the equipment BIM data acquisition unit 104, the decision unit 105, and the output unit 106 may read “circuit”, “step”, “procedure”, “processing” or “circuitry”.

Additionally, the data processing device 100 may be realized by a processing circuit. The processing circuit is, for example, a logic IC (Integrated Circuit), a GA (Gate Array), an ASIC (Application Specific Integrated Circuit), and an FPGA (Field-Programmable Gate Array).

In this case, each of the equipment BIM object acquisition unit 101, the architecture BIM data acquisition unit 103, the equipment BIM data acquisition unit 104, the decision unit 105, and the output unit 106 is realized as a part of the processing circuit.

Note that a superordinate concept of the processor and the processing circuit is referred to as “processing circuitry” in the present specification.

That is, each of the processor and the processing circuit is a specific example of “processing circuitry”.

### REFERENCE SIGNS LIST

100: data processing device; 101: equipment BIM object acquisition unit; 102: equipment BIM object storage unit; 103: architecture BIM data acquisition unit; 104: equipment BIM data acquisition unit; 105: decision unit; 106: output unit; 107: specification compliance status data acquisition unit; 108: acquired data storage unit; 109: workload data acquisition unit; 110: correction value candidate data acquisition unit; 150: decision result; 160: decision result; 170: decision result; 200: construction designer terminal; 201: architecture BIM data; 300: equipment manufacturer terminal; 301: equipment BIM object; 400: equipment designer terminal; 401: equipment BIM data; 500: data processing system; 600: installation operator terminal; 601: specification compliance status data; 602: workload volume data; 603: specification compliance status data; 604: specification compliance status data; 700: maintenance provider terminal; 701: workload volume data; 702: correction value candidate data; 901: processor; 902: main memory unit; 903: auxiliary storage device; 904: communication device; 905: input and output device.

1. A data processing device comprising:
processing circuitry
to acquire specification compliance status data indicating whether equipment is installed in compliance with an installation specification being a specification on installation of the equipment for each past case of installation with respect to a plurality of past cases of installation of the equipment;
to acquire workload volume data indicating a workload volume required for either an installation work of the equipment or a maintenance work of the equipment after installation for each past case of installation with respect to the plurality of past cases of installation; and
to decide whether correction of the installation specification is necessary, using the specification compliance status data and the workload volume data in the plurality of past cases of installation.

2. The data processing device as defined in claim 1, wherein the processing circuitry decides whether the installation specification contributes to reduction of a workload, using either a total value or a mean value of the workload volume in a past case of installation where the equipment is installed in compliance with the installation specification, and either a total value or a mean value of the workload volume in a past case of installation where the equipment is installed in non-compliance with the installation specification, and decides whether the correction of the installation specification is necessary.

3. The data processing device as defined in claim 1, wherein the processing circuitry examines independency of the workload volume in a past case of installation where the equipment is installed in non-compliance with the installation specification and the workload volume in a past case of installation where the equipment is installed in compliance with the installation specification, and decides whether the correction of the installation specification is necessary.

4. The data processing device as defined in claim 1, wherein the installation specification is defined by a numerical value,
the processing circuitry acquires a plurality of pieces of correction value candidate data each indicating a candidate for a correction value for the installation specification as a correction value candidate, and
the processing circuitry selects a correction value candidate from among a plurality of correction value candidates indicated in the plurality of pieces of correction value candidate data as a correction value for the installation specification, when the correction of the installation specification is decided to be necessary.

5. The data processing device as defined in claim 4, wherein the processing circuitry counts the number of times the correction value candidate appears in the plurality of pieces of correction value candidate data for each correction value candidate, and selects a correction value candidate from among the plurality of correction value candidates as the correction value for the installation specification based on a counting result.

6. The data processing device as defined in claim 4, wherein the processing circuitry acquires a plurality of pieces of correction value candidate data each associated with a past case of installation among the plurality of past cases of installation, and
the processing circuitry decides whether the equipment is installed in compliance with the installation specification in a past case of installation associated, for each piece of correction value candidate data, counts the number of times the equipment is installed in compliance with the installation specification in the past case of installation associated, for each correction value candidate, and
selects a correction value candidate from among the plurality of correction value candidates as the correction value for the installation specification based on a counting result.

7. The data processing device as defined in claim 4, wherein the processing circuitry acquires a plurality of pieces of correction value candidate data each associated with a past case of installation among the plurality of past cases of installation, and
the processing circuitry analyzes a correlation between the correction value candidate and the workload volume in the plurality of past cases of installation when the correction of the installation specification is decided to be necessary, and selects a correction value candidate from among the plurality of correction value candidates as the correction value for the installation specification based on an analysis result.

8. A data processing method comprising:
acquiring specification compliance status data indicating whether equipment is installed in compliance with an installation specification being a specification on installation of the equipment for each past case of installation with respect to a plurality of past cases of installation of the equipment;
acquiring workload volume data indicating a workload volume required for either an installation work of the equipment or a maintenance work of the equipment after installation for each past case of installation with respect to the plurality of past cases of installation; and
deciding whether correction of the installation specification is necessary, using the specification compliance status data and the workload volume data in the plurality of past cases of installation.

9. A non-transitory computer readable medium storing a data processing program to cause a computer to perform:
a specification compliance status data acquisition process to acquire specification compliance status data indicating whether equipment is installed in compliance with an installation specification being a specification on installation of the equipment for each past case of installation with respect to a plurality of past cases of installation of the equipment;
a workload data acquisition process to acquire workload volume data indicating a workload volume required for either an installation work of the equipment or a maintenance work of the equipment after installation for each past case of installation with respect to the plurality of past cases of installation; and
a decision process to decide whether correction of the installation specification is necessary, using the specification compliance status data and the workload volume data in the plurality of past cases of installation.
